(19) United States
(12) Patent Application Publication
(10) Pub. No.: US 2026/0253329 A1
(43) Pub. Date: Aug. 27, 2026

(54) METHOD AND SYSTEM FOR PORTABLE PERCEPTION SENSOR-BASED THREE-DIMENSIONAL MAPPING

(71) Applicant: INVENSENSE, INC, SAN JOSE, CA (US)

(72) Inventors: Andre Staffa, Calgary (CA); Jacques Georgy, Calgary (CA); Christopher Goodall, Calgary (CA)

(21) Appl. No.: 19/545,293

(22) Filed: Feb. 20, 2026

Related U.S. Application Data
(60) Provisional application No. 63/761,843, filed on Feb. 21, 2025.

(51) Int. Cl. G06T 17/05; G01C 21/00; G01C 21/20; G06T 5/80

(52) U.S. Cl. CPC G06T 17/05; G01C 21/206; G01C 21/383; G01C 21/3841; G06T 5/80

(57) ABSTRACT

Techniques are disclosed to build a map for a venue encompassing at least one portable device conveyed by a user using perception sensor data from the portable device. The techniques are scalable to accommodate any complexity of the venue and are configured to be operable for limited resources of the at least one portable device. Motion sensor data may be obtained from a sensor assembly of the portable device. Perception sensor data is also obtained for the portable device. A navigation solution is generated and a 3D geometrical map is built for the venue using perception sensor data based at least in part on the navigation solution. Building the map at least partially compensates for sensor drift, accommodates the limited resources of the at least one portable device and provides scalability despite the complexity of the venue by building individual 3D maps for zones. Subsets of the spatially related zones are corrected and the correction is propagated to each zone in the subset so that each 3D map of the zones in each subset are corrected. Corrected subsets are aggregated and corrected by forming a plurality of aggregate transformations followed by correcting each 3D map of the zones in each subset of the aggregate of subsets. A geodetic correction of the aggregated corrected subsets is performed along with geodetically correcting the 3D maps of the zones in each subset in the aggregate of subsets.

### CROSS-REFERENCE TO RELATED APPLICATIONS

This application claims priority from and benefit of U.S. Provisional Patent Application Ser. No. 63/761,843, filed Feb. 21, 2025, which is entitled “METHOD AND SYSTEM FOR PORTABLE IMAGING SENSOR-BASED THREE-DIMENSIONAL MAPPING,” is assigned to the assignee hereof, and is incorporated by reference in its entirety.

### FIELD OF THE PRESENT DISCLOSURE

This disclosure generally relates to building three-dimensional (3D) image based maps for indoor environments using information obtained with one or more portable devices. More particularly, the imaging may be in the hyperspectral range and includes the optical imaging range and the infra-red (IR) imaging range employing, for example, an optical camera, a thermal camera, an infra-red imaging sensor, and/or light detection and ranging (LiDAR or lidar) system, as well as potentially other types of perceptions sensors such as a radar system, an ultrasonic sensor or other suitable sensor that records samples to help classify objects detected in the surrounding environment. The techniques of this disclosure scale for venues of any size and complexity and accommodate the limited resources available to portable devices that may be conveyed by users, as well as the drift caused by using inertial sensors.

### BACKGROUND

One of the predominant challenges in the industry today is the rapid accumulation of drift in portable inertial measurement unit (IMU) devices, such as those employing accelerometers and/or gyroscopes, leading to significant inaccuracies in 3D local map generation. Even with the use of advanced light detection and ranging (LiDAR) and optical-based systems within portable devices, drift inevitably destabilizes the 3D map construction process, rendering it difficult to produce precise and usable 3D maps that are scalable for very large areas/venues. In large venues typically such maps are plagued by drift because of the aforementioned reasons. As will be appreciated, larger venues involve greater traveled distances for each portable device which necessarily exacerbates sensor drift. Likewise, greater complexity in the venue also increases drift.

The current state of portable perception sensor-based (such as LiDAR/Optical-based or other imaging sensors) technology is that such devices can only reliably map relatively smaller areas, with minimal drift and errors. These portable devices leverage their integrated sensors, such as IMU, magnetometer, barometer and optical-based systems, to capture detailed 3D data, which is sufficient for small-scale environments. However, the primary challenge arises when attempting to scale this technology to map large and complex 3D environments, such as large multi-floor buildings, skyscrapers, multi-buildings campuses or compounds, office buildings, very large factories and expansive warehouses. For example, current warehouses may even exceed ten million square feet, demonstrating the need for the ability to accommodate venues of any complexity.

These compact, portable devices with imaging or perception sensor-based capabilities (such as LiDAR/Optical-based sensors) also integrate a suite of low-cost sensors-including motion sensors such as an inertial measurement unit (IMU) (accelerometers and gyroscopes), magnetometer, barometer, and advanced optical sensors. Each device is powered by a dedicated CPU and supported by both RAM and ROM, enabling all components to work together seamlessly to create 3D environments. However, the current sensor array and hardware configuration impose computation resource limitations that prevent these devices from effectively mapping expansive, complex, large-scale 3D environments and structures. For example, portable devices have a limited amount of memory, which restricts the volume of 3D data that can be stored and processed simultaneously. As the mapped area expands the portable device struggles to retain the high-resolution data, leading to a degradation in quality. Further, the CPU capabilities of such portable devices are not sufficient to handle the intensive computations required for real-time 3D mapping of large areas. This limitation becomes evident when the portable device attempts to process and integrate vast amounts of data from the perception sensors, resulting in slower processing times and potential errors in the generated large maps. Moreover, even though initial mapping of small areas may be accurate; the accumulation of drift and errors becomes more pronounced as the area increases and gets more complex. This is due to the inherent limitations in the sensors used in these portable devices, which, over time, cause inaccuracies in the spatial data.

Correspondingly, the core problem is that existing portable devices with imaging or perception sensors such as LiDAR/Optical sensors and their technology together with the relatively low-cost consumer grade motion sensors in those devices, as is, are incapable of constructing scalable 3D maps for large and complex environments and venues. The ability to create accurate and detailed maps of large areas and venues is hindered by the portable device's inability to manage and process extensive data sets effectively. When the mapping area extends beyond its limitations, the quality of the collected data deteriorates significantly, and critical information is lost as the portable device's resources are overwhelmed.

To address these challenges, this disclosure outlines a technique with a series of methodological steps and adaptations designed to optimize the 3D data captured by imaging or perception sensors such as LiDAR and optical sensors in portable devices, enabling them to scale effectively for large complex venues despite their limited resources.

Accordingly, the techniques of this disclosure minimize these issues by implementing a system and method that comprises techniques to mitigate and decrease or nullify the various errors and drifts in the 3D maps introduced by motion sensor drift and various sensor errors. By doing so, the techniques of this disclosure help ensure the stability and accuracy of the 3D maps, allowing for indefinite scalability regardless of size and complexity of the area or venue to be mapped and despite the limited resources of portable devices. The core objective is to develop a solution (a system and method) that effectively compensates for the various errors and drifts in the built maps caused by the various sensor errors, enabling the construction of highly accurate and scalable 3D maps for outdoor/indoor environments regardless of their size and complexity and despite the limited resources of portable devices.

### SUMMARY

This disclosure includes a method for building a map for a venue encompassing at least one portable device conveyed by a user using perception sensor data from the portable device, wherein the method is scalable to accommodate any complexity of the venue and is configured to be operable for limited resources of the at least one portable device. Motion sensor data may be obtained from a sensor assembly of the portable device. Perception sensor data is also obtained for the portable device. A navigation solution is generated and a 3D geometrical map is built for the venue using perception sensor data based at least in part on the navigation solution. Building the map at least partially compensates for sensor drift, accommodates the limited resources of the at least one portable device and provides scalability despite the complexity of the venue by building individual 3D maps for zones, wherein the zones are spatially related and each zone is a partition of the venue. Subsets of the spatially related zones, wherein each subset comprises a same number of spatially related zones that are contiguous with each other, are corrected and the correction is propagated to each zone in the subset so that each 3D map of the zones in each subset are corrected. Corrected subsets are aggregated and corrected by forming a plurality of aggregate transformations followed by correcting each 3D map of the zones in each subset of the aggregate of subsets. A geodetic correction of the aggregated corrected subsets is performed along with geodetically correcting the 3D maps of the zones in each subset in the aggregate of subsets.

This disclosure also includes a system for building a map for a venue encompassing at least one portable device conveyed by a user using perception sensor data from the portable device. As with the method, the system is capable of scalability to accommodate any complexity of the venue and the system is configured to be operable for limited resources of the at least one portable device. The system may include at least one portable device having a sensor assembly configured to output motion sensor data, at least one perception sensor providing perception sensor data for the at least one portable device and at least one processor, coupled to receive the motion sensor data and the perception sensor data. Further, the at least one processor may be operative to obtain motion sensor data from a sensor assembly of the at least one portable device, obtain perception sensor data from at least one perception sensor for the at least one portable device, generate a navigation solution for the at least one portable device based at least in part on the obtained motion sensor data and build a 3D geometrical map for the venue using perception sensor data based at least in part on the navigation solution. Notably, building the map at least partially compensates for sensor drift, accommodates the limited resources of the at least one portable device and provides scalability despite the complexity of the venue by building individual 3D maps for zones, wherein the zones are spatially related and each zone is a partition of the venue, for a subset of zones, wherein each subset comprises a same number of spatially related zones that are contiguous with each other, correcting each subset of the spatially related zones and propagating the correction to each zone in the subset and correcting each 3D map of the zones in each subset, aggregating corrected subsets and correcting the aggregated corrected subsets by forming a plurality of aggregate transformations followed by correcting each 3D map of the zones in each subset of the aggregate of subsets and performing a geodetic correction of the aggregated corrected subsets and geodetically correcting the 3D maps of the zones in each subset in the aggregate of subsets.

### BRIEF DESCRIPTION OF THE DRAWINGS

FIG. 1a is schematic diagram of a device for building a map for a venue using perception sensor data with motion sensor data according to an embodiment.

FIG. 1b is schematic diagram of a system for building a map for a venue using perception sensor data with motion sensor data according to an embodiment.

FIG. 2 is s a flowchart showing a routine for building a map for a venue using perception sensor data with motion sensor data according to an embodiment.

FIG. 3 is s a flowchart showing a routine for building a map for a venue using perception sensor data with motion sensor data according to another embodiment.

FIG. 4 is a schematic representation of partitioning a venue into zones, according to an embodiment.

FIG. 5 is a schematic representation of a linear interpolation process for zones of a venue according to an embodiment.

FIG. 6 is a schematic representation of correcting the aggregated corrected subsets by forming a plurality of aggregate transformations according to an embodiment.

FIG. 7 is a schematic representation of correcting Floor/Area aggregates according to an embodiment.

FIG. 8 is a schematic representation of correcting Connector aggregates according to an embodiment.

FIG. 9 is a schematic representation of converting Cartesian coordinates to Geocentric coordinates and alignment of the map to its absolute location according to an embodiment.

FIG. 10 is a schematic representation of a backbone structure for zones of a venue according to an embodiment.

FIG. 11 is a schematic representation of a path for mapping a backbone structure within a multi-floor structure according to an embodiment.

FIG. 12 is a schematic representation of a horizontal backbone for a single-floor structure according to an embodiment.

FIG. 13 is a schematic representation of area sub-components forming an entire Floor/Area sub-structure according to an embodiment.

FIG. 14 is a schematic representation of horizontally and vertically mapped connectors according to an embodiment.

FIG. 15 is a schematic representation of a master portable device transmitting mapping data to peers according to an embodiment.

FIG. 16 is a schematic representation of a pipeline used for a multi-user parallel mapping technique for building a map of the venue according to an embodiment.

FIG. 17 is a schematic representation of a 3D structure built from a backbone and associated sub-structures according to an embodiment.

FIG. 18 is a schematic representation of aggregates differentiated by unique visual identifiers according to an embodiment.

FIG. 19 is a schematic representation of adjustments to zone subsets according to an embodiment.

FIG. 20 is a schematic representation of removal of zone subsets according to an embodiment.

FIG. 21 is a schematic representation of geodetic alignment and coordinate transformation according to an embodiment.

### DETAILED DESCRIPTION

At the outset, it is to be understood that this disclosure is not limited to particularly exemplified materials, architectures, routines, methods or structures as such may vary. Thus, although a number of such options, similar or equivalent to those described herein, can be used in the practice or embodiments of this disclosure, the preferred materials and methods are described herein.

It is also to be understood that the terminology used herein is for the purpose of describing particular embodiments of this disclosure only and is not intended to be limiting.

The detailed description set forth below in connection with the appended drawings is intended as a description of exemplary embodiments of the present disclosure and is not intended to represent the only exemplary embodiments in which the present disclosure can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the specification. It will be apparent to those skilled in the art that the exemplary embodiments of the specification may be practiced without these specific details. In some instances, well known structures and devices are shown in block diagram form in order to avoid obscuring the novelty of the exemplary embodiments presented herein.

For purposes of convenience and clarity only, directional terms, such as top, bottom, left, right, up, down, over, above, below, beneath, rear, back, and front, may be used with respect to the accompanying drawings or chip embodiments. These and similar directional terms should not be construed to limit the scope of the disclosure in any manner.

In this specification and in the claims, it will be understood that when an element is referred to as being “connected to” or “coupled to” another element, it can be directly connected or coupled to the other element or intervening elements may be present. In contrast, when an element is referred to as being “directly connected to” or “directly coupled to” another element, there are no intervening elements present.

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the exemplary wireless communications devices may include components other than those shown, including well-known components such as a processor, memory and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, performs one or more of the methods described above. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor. For example, a carrier wave may be employed to carry computer-readable electronic data such as those used in transmitting and receiving electronic mail or in accessing a network such as the Internet or a local area network (LAN). Of course, many modifications may be made to this configuration without departing from the scope or spirit of the claimed subject matter.

The various illustrative logical blocks, modules, circuits and instructions described in connection with the embodiments disclosed herein may be executed by one or more processors, such as one or more motion processing units (MPUs), digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structure or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of an MPU and a microprocessor, a plurality of microprocessors, one or more microprocessors in conjunction with an MPU core, or any other such configuration.

Unless defined otherwise, all technical and scientific terms used herein have the same meaning as commonly understood by one having ordinary skill in the art to which the disclosure pertains.

Finally, as used in this specification and the appended claims, the singular forms “a, “an” and “the” include plural referents unless the content clearly dictates otherwise.

The focus of this disclosure is the development of a portable imaging sensor-based system and method for three-dimensional (3D) map construction of indoor environments that scales even for very large and complex areas and venues, and that is tailored for positioning applications that can work indoors or outdoors. For the remainder of this disclosure, it will be referred to as either an imaging sensor-based system or as an optical sensor-based system, while it is understood it may contain the infra-red spectral range not just the optical spectral range and further that other perception-based sensors such as radar or ultrasound may also be employed. This portable imaging sensor-based system (or optical sensor-based system) comprises a portable device with the optical sensor(s) such as LiDAR, cameras and vision-based systems. Cameras can include any type of cameras comprising but not limited to: stereo camera, or monocular, fisheye cameras, thermal cameras, infra-red (IR) cameras, or hyperspectral cameras. This system is for 3D mapping that scales for larger and more complex venues. This system provides a comprehensive 3D map, whether: 3D point clouds, 3D occupancy maps, or 3D mesh maps comprising of vertices, faces, normals, floor planes, depth data, and positioning information. By integrating imaging, perception or optical sensors such as LiDAR/cameras with other built-in sensors in the portable device comprising motion sensors (that are typically low-cost consumer grade sensors) such as, for example, an IMU consisting of accelerometers and gyroscopes, the portable device constructs maps of outdoor/indoor environments, which can be scaled to any size and shape. Maps can be generated based on any source of perception sensor information, such as vision data from mono/stereo/thermal cameras, lidar, imaging radar, ultrasound or other types of sensors.

The techniques of this disclosure are primarily described in the context of a portable device that may be conveyed by a user that functions as a platform such as when being carried or transported by a pedestrian or a user undergoing on foot motion, which as discussed above, may include the user having the portable device in the their hand for texting or viewing purposes (wherein the hand may also move), at their ear, in hand and dangling/swinging, in a belt clip, in a pocket, among others, where such use cases can change with time and even each use case can have a changing orientation with respect to the user. However, it should be appreciated that the portable device may be conveyed by other types of platforms, such as a wheel-based vehicle or other similar vessel intended for use on land, but may also be marine or airborne. As such, the platform may also be considered a vehicle. As will be appreciated, motion sensor data includes information from accelerometers, gyroscopes, or an IMU. Inertial sensors are self-contained sensors that use gyroscopes to measure the rate of rotation/angle, and accelerometers to measure the specific force (from which acceleration is obtained). Inertial sensors data may be used in an INS, which is a non-reference based relative positioning system. Using initial estimates of position, velocity and orientation angles of the moving platform as a starting point, the INS readings can subsequently be integrated over time and used to determine the current position, velocity and orientation angles of the platform. Typically, measurements are integrated once for gyroscopes to yield orientation angles and twice for accelerometers to yield position of the platform incorporating the orientation angles. Thus, the measurements of gyroscopes will undergo a triple integration operation during the process of yielding position. Inertial sensors alone, however, are unsuitable for accurate positioning because the required integration operations of data results in positioning solutions that drift with time, thereby leading to an unbounded accumulation of errors. Integrating absolute navigational information, such as from GNSS, with the motion sensor data can help mitigate such errors.

Further, it may be expected that the portable device is not “strapped,” “strapped down,” or “tethered” to the platform when it is physically connected to the platform in a fixed manner that does not change with time during navigation, in the case of strapped devices, the relative position and orientation between the device and platform does not change with time during navigation. Notably, in strapped configurations, it is assumed that the mounting of the device to the platform is in a known orientation. Rather, a portable device is typically “non-strapped”, or “non-tethered” when the device has some mobility relative to the platform (or within the platform), meaning that the relative position or relative orientation between the device and platform may change with time during navigation. Under these conditions, the relative orientation of the device with respect to the platform may vary. The device may be “non-strapped” in two scenarios: where the mobility of the device within the platform is “unconstrained”, or where the mobility of the device within the platform is “constrained.” One example of “unconstrained” mobility may be a person moving on foot and having a portable device such as a smartphone in the their hand for texting or viewing purposes (hand may also move), at their ear, in hand and dangling/swinging, in a belt clip, in a pocket, among others, where such use cases can change with time and even each use case can have a changing orientation with respect to the user. Another example where the mobility of the device within the platform is “unconstrained” is a person in a vessel or vehicle, where the person has a portable device such as a smartphone in the their hand for texting or viewing purposes (hand may also move), at their ear, in a belt clip, in a pocket, among others, where such use cases can change with time and even each use case can have a changing orientation with respect to the user. An example of “constrained” mobility may be when the user enters a vehicle and puts the portable device (such as smartphone) in a rotation-capable holder or cradle. In this example, the user may rotate the holder or cradle at any time during navigation and thus may change the orientation of the device with respect to the platform or vehicle. Thus, when non-strapped, the mobility of the device may be constrained or unconstrained within the platform and may be moved or tilted to any orientation within the platform and the techniques of this disclosure may still be applied under all of these conditions. As such, some embodiments described below include a portable, hand-held device that can be moved in space by a user and its motion, location and/or orientation in space therefore sensed. The techniques of this disclosure can work with any type of portable device as desired, including a smartphone or the other exemplary devices noted below. It will be appreciated that such devices are often carried or associated with a user and thus may benefit from providing navigation solutions using a variety of inputs. For example, such a handheld device may be a mobile phone (e.g., cellular phone, a phone running on a local network, or any other telephone handset), tablet, personal digital assistant (PDA), video game player, video game controller, navigation device, wearable device (e.g., glasses, watch, belt clip), fitness tracker, virtual or augmented reality equipment, mobile internet device (MID), personal navigation device (PND), digital still camera, digital video camera, binoculars, telephoto lens, portable music, video or media player, remote control, or other handheld device, or a combination of one or more of these devices. However, the techniques of this disclosure may also be applied to other types of devices that are not handheld, including devices integrated with autonomous or piloted vehicles whether land-based, aerial, or underwater vehicles, or equipment that may be used with such vehicles. As an illustration only and without limitation, the platform may be a drone, also known as an unmanned aerial vehicle (UAV).

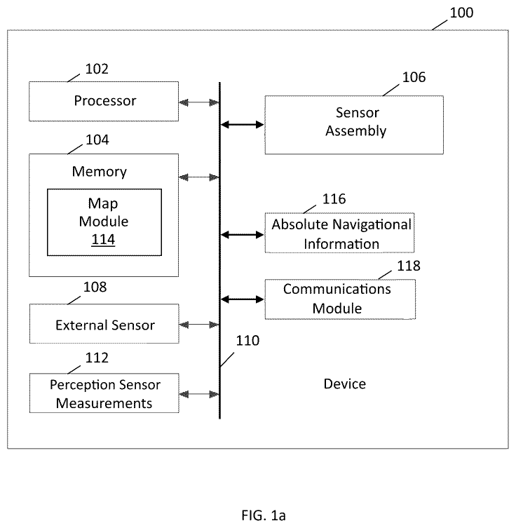

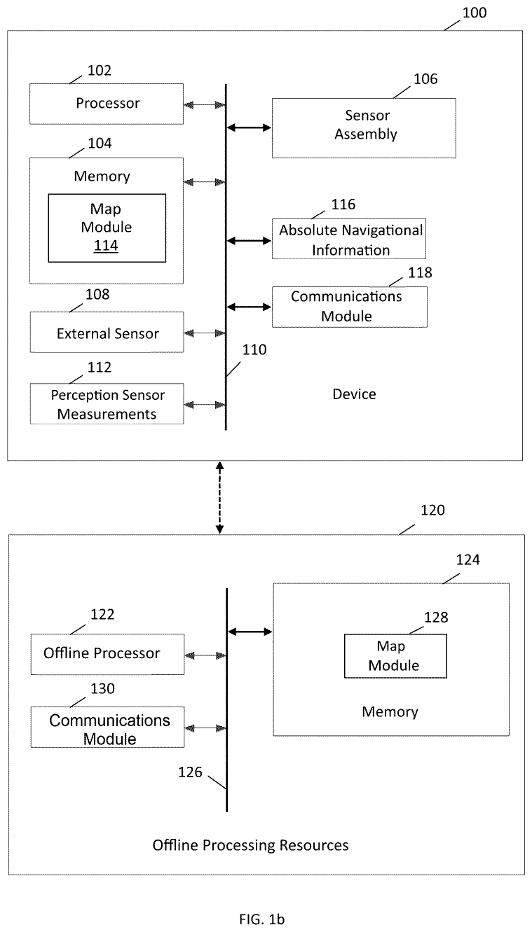

To help illustrate aspects of this disclosure, features of a suitable portable device 100 are depicted in FIG. 1a with high level schematic blocks. As will be appreciated, portable device 100 may be implemented as a device or apparatus, such a strapped, non-strapped, tethered, or non-tethered device as described above, which when non-strapped, the mobility of the device may be constrained or unconstrained within the platform and may be moved or tilted to any orientation within the platform. It should be understood that in many embodiments, device 100 will be portable and its relative orientation with respect to a user may be not known a priori and that relative orientation may change at any time. Nevertheless, it should be understood that the techniques of this disclosure may be extended to the less difficult application in which device is strapped to a platform in a known orientation that does not vary. As shown, portable device 100 includes a processor 102, which may be one or more microprocessors, central processing units (CPUs), or other processors to run software programs, which may be stored in memory 104, associated with the functions of device 100. Multiple layers of software can be provided in memory 104, which may be any combination of computer readable medium such as electronic memory or other storage medium such as hard disk, optical disk, etc., for use with the processor 102. For example, an operating system layer can be provided for device 100 to control and manage system resources in real time, enable functions of application software and other layers, and interface application programs with other software and functions of device 100. Similarly, different software application programs such as menu navigation software, games, camera function control, navigation software, communications software, such as telephony or wireless local area network (WLAN) software, or any of a wide variety of other software and functional interfaces can be provided. In some embodiments, multiple different applications can be provided on a single device 100, and in some of those embodiments, multiple applications can run simultaneously.

Portable device 100 includes at least one sensor assembly 106 for providing motion sensor data representing motion of device 100 in space, including inertial sensors such as an accelerometer and a gyroscope, other motion sensors including a magnetometer, a pressure sensor or others may be used in addition. Motion sensors represent a self-contained source of navigational information. Depending on the configuration, sensor assembly 106 measures one or more axes of rotation and/or one or more axes of acceleration of the device. In one embodiment, sensor assembly 106 may include inertial rotational motion sensors or inertial linear motion sensors. For example, the rotational motion sensors may be gyroscopes to measure angular velocity along one or more orthogonal axes and the linear motion sensors may be accelerometers to measure linear acceleration along one or more orthogonal axes. In one aspect, three gyroscopes and three accelerometers may be employed, such that a sensor fusion operation performed by processor 102, or other processing resources of device 100, combines data from sensor assembly 106 to provide a six axis determination of motion or six degrees of freedom (6DOF). Still further, sensor assembly 106 may include a magnetometer measuring along three orthogonal axes and output data to be fused with the gyroscope and accelerometer inertial sensor data to provide a nine axis determination of motion. Likewise, sensor assembly 106 may also include a pressure sensor to provide an altitude determination that may be fused with the other sensor data to provide a ten axis determination of motion. As desired, sensor assembly 106 may be implemented using Micro Electro Mechanical System (MEMS), allowing integration into a single small package. Exemplary details regarding suitable configurations sensor assembly 106 implemented as a motion processing unit (MPU) may be found in, commonly owned U.S. Pat. No. 8,250,921, issued Aug. 28, 2012, and U.S. Pat. No. 8,952,832, issued Feb. 10, 2015, which are hereby incorporated by reference in their entirety. Suitable implementations for such MPUs are available from InvenSense, Inc. of San Jose, Calif.

Portable device 100 also implements at least one perception sensor providing perception sensor measurements 112, including one or more of an optical camera, a thermal camera, an IR imaging sensor, a light detection and ranging (LiDAR or lidar) system, a radar system, an ultrasonic sensor or other suitable sensor that records images or samples to help classify objects detected in the surrounding environment. As will be discussed in detail below, the techniques of this disclosure involve employing perception sensor data 112 with the motion sensor data provided by sensor assembly 106 (or other sensors, such as external sensor 108) to provide the navigation solution. Device 100 obtains perception sensor data 112 from any perception sensor such as those indicated above, which may be integrated with device 100, may be associated or connected with device 100, may be part of the platform or may be implemented in any other desired manner.

Accordingly, one suitable type of perception sensor involves vision, such as in the form of optical samples from a camera or similar apparatus and may include the IR hyperspectral imaging range. Vison sensors provide the system with visual data to perceive the scene components and facilitating tasks such as object recognition, terrain analysis, and even decision-making based on visual inputs. Data could come from either mono camera, stereo cameras, or thermal camera making the navigation system to interact with its environment in a way that mimics human vision. Mono cameras capture single images, providing visual data like human eyesight which are particularly useful for tasks like lane detection, traffic sign recognition, and object classification. Mono cameras are simpler, cost-effective, and require less computational power for data processing. On the other hand, stereo cameras are using two or more lenses, capture images from slightly different angles, allowing for depth perception through disparity maps which is ideal for 3D mapping, obstacle detection in depth, and enhanced environmental understanding. Stereo cameras provide more detailed spatial information, crucial for precise navigation and complex decision-making processes. The vision system interprets visual cues from the surroundings, essential for understanding the context of the environment. Combining visual data with other types of information, such as radar, GNSS, IMU, and odometer inputs, the system can achieve a multi-dimensional view of its surroundings, crucial for accurate positioning and navigation in complex urban environments.

Still further, device 100 may also employ external sensor 108. As used herein, “external” means a sensor that is not integrated with sensor assembly 106 and may be remote or local to device 100. Also alternatively or in addition, sensor assembly 106 and/or external sensor 108 may be configured to measure one or more other aspects about the environment surrounding device 100. This is optional and not required in all embodiments. For example, a pressure sensor and/or a magnetometer may be used to refine motion determinations. Although described in the context of one or more sensors being MEMS based, the techniques of this disclosure may be applied to any sensor design or implementation.

In the embodiment shown, processor 102, memory 104, sensor assembly 106, and other components of device 100 may be coupled through bus 110, which may be any suitable bus or interface, such as a peripheral component interconnect express (PCIe) bus, a universal serial bus (USB), a universal asynchronous receiver/transmitter (UART) serial bus, a suitable advanced microcontroller bus architecture (AMBA) interface, an Inter-Integrated Circuit (I2C) bus, a serial digital input output (SDIO) bus, a serial peripheral interface (SPI) or other equivalent. Depending on the architecture, different bus configurations may be employed as desired. For example, additional buses may be used to couple the various components of device 100, such as by using a dedicated bus between processor 102 and memory 104.

Algorithms, routines or other instructions for processing sensor data, may be employed by map module 114 to perform this any of the operations associated with the techniques of this disclosure, including performing one or more aspects of 3D map building for the venue. As will be appreciated in light of the materials in this disclosure, the map building may include a process of zone partitioning to facilitate the creation of scalable 3D maps. In conjunction with zone partitioning, the techniques of this disclosure include a multi-level correction framework designed to enhance the accuracy, scalability, and reliability of 3D map construction. For example, four stages of correction may be employed as detailed below. In one aspect, a navigation solution based on the motion sensor data may be provided. As used herein, a navigation solution comprises at least position and may also include attitude (or orientation) and/or velocity. Determining the navigation solution may involve sensor fusion or similar operations performed by the processor 102, which may be using the memory 104, or any combination of other processing resources.

Correspondingly, device 100 also may have a source of absolute navigational information 116, such as a Global Navigation Satellite System (GNSS) receiver, including without limitation the Global Positioning System (GPS), the Global Navigation Satellite System (GLONASS), Galileo and/or Beidou, as well as WiFi™ positioning, cellular tower positioning, Bluetooth™ positioning beacons or other similar methods when deriving a navigation solution. Map module 114 may also be configured to use information from a wireless communication protocol to provide a navigation solution determination using signal trilateration. Any suitable protocol, including cellular-based and wireless local area network (WLAN) technologies such as Universal Terrestrial Radio Access (UTRA), Code Division Multiple Access (CDMA) networks, Global System for Mobile Communications (GSM), the Institute of Electrical and Electronics Engineers (IEEE) 802.16 (WiMAX), Long Term Evolution (LTE), IEEE 802.11 (WiFi™) and others may be employed. The source of absolute navigational information represents a “reference-based” system that depend upon external sources of information, as opposed to self-contained navigational information that is provided by self-contained and/or “non-reference based” systems within a device/platform, such as sensor assembly 106 as noted above.

In some embodiments, device 100 may include communications module 118 for any suitable purpose, including for transmitting map building information derived as the platform traverses an area. Communications module 118 may employ a Wireless Local Area Network (WLAN) conforming to Institute for Electrical and Electronic Engineers (IEEE) 802.11 protocols, featuring multiple transmit and receive chains to provide increased bandwidth and achieve greater throughput. For example, the 802.1 lad (WiGIG™) standard includes the capability for devices to communicate in the 60 GHz frequency band over four, 2.16 GHz-wide channels, delivering data rates of up to 7 Gbps. Other standards may also involve the use of multiple channels operating in other frequency bands, such as the 5 GHz band, or other systems including cellular-based and WLAN technologies such as Universal Terrestrial Radio Access (UTRA), Code Division Multiple Access (CDMA) networks, Global System for Mobile Communications (GSM), IEEE 802.16 (WiMAX), Long Term Evolution (LTE), other transmission control protocol, internet protocol (TCP/IP) packet-based communications, or the like may be used. In some embodiments, multiple communication systems may be employed to leverage different capabilities. Typically, communications involving higher bandwidths may be associated with greater power consumption, such that other channels may utilize a lower power communication protocol such as BLUETOOTH®, ZigBee®, ANT or the like. Further, a wired connection may also be employed. Generally, communication may be direct or indirect, such as through one or multiple interconnected networks. As will be appreciated, a variety of systems, components, and network configurations, topologies and infrastructures, such as client/server, peer-to-peer, or hybrid architectures, may be employed to support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the techniques as described in various embodiments.

It will also be appreciated that the techniques of this disclosure may also be implemented using a system that includes at least one portable device and offline processing resources. To help illustrate, FIG. 1b depicts one suitable architecture of a system that features portable device 100 as discussed above along with offline processing resources 120 using high level schematic blocks. Offline processing resources may include offline processor 122 that is in communication with memory 124 over bus 126. As will be described in further detail below, offline processor 122 may execute instructions stored in memory 124 that are represented as functional blocks, including map module 128, which may be configured to perform one or more aspects of 3D map building for the venue. Offline processing resources 120 includes a communications module 130 to exchange information with device 100, using any suitable protocol including those noted above. Portable device 100 and offline processing resources 120 may communicate either directly or indirectly, such as through multiple interconnected networks. As will be appreciated, a variety of systems, components, and network configurations, topologies and infrastructures, such as client/server, peer-to-peer, or hybrid architectures, may be employed to support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the techniques as described in various embodiments.

As noted, portable device 100, with map module 114, and/or offline processing resources 120, with map module 128, may be configured to perform the aspects of 3D map building for the venue as detailed in this disclosure. Further, any or all of the functions described as being performed may be performed by any number of discrete devices in communication with each other, or may be performed by device 100 itself in other suitable system architectures. Accordingly, it should be appreciated that any suitable division of processing resources may be employed whether within one device, among a plurality of devices, or in conjunction with any type of remote processing resources. Further, aspects implemented in software may include but are not limited to, application software, firmware, resident software, microcode, etc., and may take the form of a computer program product accessible from a computer-usable or computer-readable medium providing program code for use by or in connection with a computer or any instruction execution system, such as host processor 102, offline processor 122, a dedicated processor or any other processing resources of portable device 100, offline processing resources 120 or other remote processing resources, or may be implemented using any desired combination of software, hardware and firmware.

As will be appreciated, processor 102 and/or other processing resources of device 100 may be one or more microprocessors, central processing units (CPUs), or other processors which run software programs for device 100 or for other applications related to the functionality of device 100. For example, different software application programs such as menu navigation software, games, camera function control, navigation software, and phone or a wide variety of other software and functional interfaces can be provided. In some embodiments, multiple different applications can be provided on a single device 100, and in some of those embodiments, multiple applications can run simultaneously on the device 100. Multiple layers of software can be provided on a computer readable medium such as electronic memory or other storage medium such as hard disk, optical disk, flash drive, etc., for use with processor 102. For example, an operating system layer can be provided for device 100 to control and manage system resources in real time, enable functions of application software and other layers, and interface application programs with other software and functions of device 100. In some embodiments, one or more motion algorithm layers may provide motion algorithms for lower-level processing of raw sensor data provided from internal or external sensors. Further, a sensor device driver layer may provide a software interface to the hardware sensors of device 100. Some or all of these layers can be provided in memory 104 for access by processor 102 or in any other suitable architecture. Embodiments of this disclosure may feature any desired division of processing between processor 102 and other processing resources, as appropriate for the applications and/or hardware being employed. Aspects implemented in software may include but are not limited to, application software, firmware, resident software, microcode, etc, and may take the form of a computer program product accessible from a computer-usable or computer-readable medium providing program code for use by or in connection with a computer or any instruction execution system, such as processor 102, a dedicated processor or any other processing resources of device 100.

A state estimation technique, such as a filter, includes a prediction phase and an update phase (which may also be termed a measurement update phase) may be used to when generating the integrated and revised integrated navigation solutions, which as noted includes at least position and may also include attitude (or orientation) and/or velocity. A state estimation technique also uses a system model and measurement model(s) based on what measurements are used. The system model is used in the prediction phase, and the measurement model(s) is/are used in the update phase. As such, the state estimation techniques of this disclosure use a measurement model for the perception sensor data so that the obtained perception sensor data directly update the state estimation technique. Further, according to this disclosure, the state estimation technique is optionally nonlinear. The nonlinear models do not suffer from approximation or linearization and can enhance the navigation solution of the device when using very low-cost low-end inertial sensors. The optical measurement model(s) is/are nonlinear. The system models can be linear or nonlinear. The system model may be a linear or nonlinear error-sate system model. The system model may be a total-state system model, in most cases total-state system models are nonlinear. In the total-state approach, the state estimation or filtering technique is estimating the state of the device itself (such as position, velocity, and attitude of the device), the system model or the state transition model used is the motion model itself, which in case of inertial navigation is a nonlinear model, this model is a total-state model since the estimated state is the state of the navigation device itself. In the error-state approach, the motion model is used externally in what is called inertial mechanization, which is a nonlinear model as mentioned earlier, the output of this model is the navigation states of the module, such as position, velocity, and attitude. The state estimation or filtering technique estimates the errors in the navigation states obtained by the mechanization, so the estimated state vector by this state estimation or filtering technique is for the error states, and the system model is an error-state system model which transitions the previous error-state to the current error-state. The mechanization output is corrected for these estimated errors to provide the corrected navigation states, such as corrected position, velocity and attitude. The estimated error-state is about a nominal value which is the mechanization output, the mechanization can operate either unaided in an open loop mode, or can receive feedback from the corrected states, this case is called closed-loop mode. Linear state estimation techniques, such as a Kalman filter (KF) or an extended Kalman filter (EKF) require linearized approximations while nonlinear techniques of this disclosure may provide a more accurate navigation solution for the device by avoiding the need for approximation by linearization.

Different architectures may be employed for the integration of data using state estimation techniques. Loosely-coupled integration uses an estimation technique to integrate motion sensors (inertial sensors) data and other source of information in the position domain. So, each source of information has to have its own separate technique to estimate position for this source alone, then all positions from all separate techniques are combined together in the loosely-couple integration. Tightly coupled integration uses an estimation technique to integrate motion sensor (inertial sensors) readings with raw measurements from another source of information using a single master filter. The raw measurements from this other source of information are integrated directly using this same single filter using appropriate measurement model for these raw measurement without any need to estimate position from them first.

As will be described, the techniques of this disclosure build a map for a venue encompassing at least one portable device conveyed by a user using perception sensor data from the portable device. In light of the discussion above, the method is scalable to accommodate any complexity of the venue and the method is configured to be operable for limited resources of the at least one portable device, as well as at least partially compensating for sensor drift. To overcome the inherent limitations of existing portable devices in constructing scalable 3D maps, this disclosure introduces a zone-based partitioning strategy. This method divides the 3D environment into discrete zones, each assigned a 3D transformation matrix that serves as the foundation for a multi-level correction framework. This approach not only addresses resource constraints but also ensures scalability and precision in constructing large and complex 3D maps.

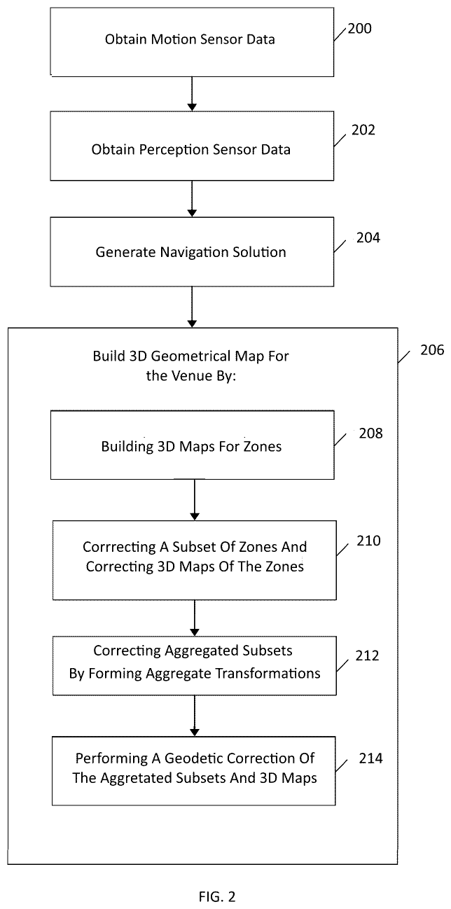

To help illustrate, FIG. 2 depicts on suitable routine in which motion sensor data is obtained from a sensor assembly of the at least one portable device in 200. Likewise, perception sensor data is obtained from at least one perception sensor for the at least one portable device in 202. A navigation solution for the at least one portable device is based at least in part on the obtained motion sensor data in 204. Correspondingly, a 3D geometrical map for the venue may be built using the perception sensor data based at least in part on the navigation solution in 206. As detailed in this disclosure, building the map at least partially compensates for sensor drift, accommodates the limited resources of the at least one portable device and provides scalability despite the complexity of the venue. As indicated in FIG. 2, the overall process of building the 3D geometrical map for the venue may involve a series of suboperations. Notably, the map may be built by generating individual 3D maps for zones in 208, wherein the zones are spatially related and each zone is a partition of the venue. Next, subsets of spatially related zones may be corrected and propagated to each zone in the subset to correct each 3D map of the zones for each subset in 210. Each subset may have a same number of spatially related zones that are contiguous with each other. Then, corrected subsets are aggregated so that the aggregated corrected subsets may be jointly corrected by forming a plurality of aggregate transformations and then correcting each 3D map of the zones in each subset of the aggregate of subsets in 212. Correspondingly, a geodetic correction of the aggregated corrected subsets may be performed in conjunction with geodetically correcting the 3D maps of the zones in each subset in the aggregate of subsets in 214.

As will be appreciated, the techniques of this disclosure help achieve the goals of compensating for sensor drift, accommodating the limited resources of the portable device and providing scalability despite the complexity of the venue using the partitioning strategy employing the zones noted above. The division of the venue into the zones may be based on any desired criteria, including the capabilities of the portable device(s) being used. Notably, the techniques of this disclosure may be applied regardless of the number and characteristics of the zones into which the venue is partitioned.

Multi-level corrections may be applied to zones, to subsets of the zones and to aggregates of the subsets of zones. For example, linear interpolations may be performed to obtain the subsets of zones according to 208 in FIG. 2. Further, an aggregate 3D transformation matrix product may be used for correcting each subset so that the correction may be propagated to each zone in the subset in 210. Next, corrected subsets are aggregated so that the aggregated corrected subsets may be corrected by forming a plurality of aggregate transformations and then correcting each 3D map of the zones in each subset of the aggregate of subsets in 212. Still further, a geodetic correction of the aggregated corrected subsets may be performed in conjunction with geodetically correcting the 3D maps of the zones in each subset in the aggregate of subsets involving the conversion of coordinates to the geodetic frame in 214.

In accordance with the partitioning strategy discussed above, aggregates of zone subsets may be spatially related and organized into different structural hierarchies. Using these organization augment the other techniques of this disclosure to allow further scalability for even more complex venues that may represent increased demands. For example, the structural hierarchies allow any arbitrarily sized venue to be managed by employing as many aggregates as needed. Notably, this still accommodates the limited resources of the at least one portable device and also further improves the partial compensation for sensor drift.

For example, the techniques of this disclosure provide further scalability despite the complexity of the venue for more complex venues, while still accommodating the limited resources of the at least one portable device and while further improving the compensation for sensor drift, wherein the sensor drifts grow larger for the more complex venue. The furthering of capabilities and scalability are provided by identifying a primary structure that links spatially related zones throughout the venue. The primary structure may connect or have a direct link to all floors or areas in the venue. Likewise, secondary structures of spatially related zones may be identified in relation to the primary structure, such as floors or areas of the venue. Further, other structures such as connectors may relate the secondary structures to the primary structure. Again, each connector is characterized by linking spatially related zones. Moreover, the primary structure, the secondary structure and/or the connectors may be aggregates of subsets of spatially related zones. Accordingly, in one implementation, the structures are at least composed of subsets of spatially related zones and may have the same number of zones in each subset. In other implementations, any of the structures may be composed of aggregates of the subsets. Scalability is achieved by employing as many secondary structures and/or connectors as necessary in light of the complexity of the venue and the capabilities of the portable devices being used.

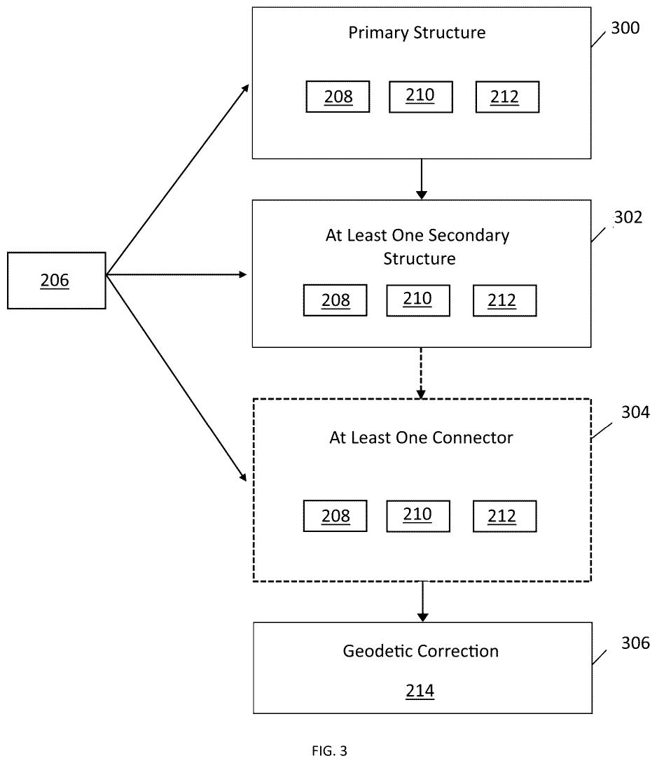

To help illustrate, FIG. 3 schematically depicts operations associated with showing a routine for building a map for a venue using perception sensor data with motion sensor data in the context of the hierarchical structures noted above. As shown, operations associated with building a 3D geometrical map for the venue using perception sensor data may involve identifying a primary structure linking spatially related zones as indicated by 300. One or more corrections as discussed above may be applied to the identified primary structure including the correction of zones (such as represented by 208), correction of subsets of zones (such as represented by 210), and/or correction of aggregated subsets of zones (such as represented by 212). Next, at least one secondary structure related to the primary structure may be identified in 302. As noted above, each secondary structure links spatially related zones and similar corrections may also be performed with respect to the these one or more secondary structures as indicated. Still further, an optional step of identifying one or more connectors may be performed in 304, such that each connector relates to at least two of the secondary structures related to the primary structure. Again, each connector may link spatially related zones and any of the corrections discussed above may be applied as indicated. Operations associated with performing geodetic corrections may the be applied in 306 as indicated or at any other suitable stage. This partitioning strategy provides further scalability despite the complexity of the venue for more complex venues, while still accommodating the limited resources of the at least one portable device and while further improving the compensation for sensor drift, wherein the sensor drifts grow larger for the more complex venue. For example, a greater number of secondary structures may be identified and/or one or more connectors may be identified to accommodate increased complexity of the venue.

The techniques of this disclosure also permit the gathering of perception sensor data to be performed by a plurality of portable devices. For example, at least one additional portable device may be conveyed by another user. As such, motion sensor data and perception sensor data may be obtained from the of the additional portable device and a navigation solution is generated for the additional portable device. A partial 3D geometrical map for at least a portion of the venue may then be built using the perception sensor data from the additional portable device. As a result, the 3D geometrical map for the venue may be built based on a partial 3D geometrical map for at least a portion of the venue using perception sensor data obtained by the at least one portable device for and on the partial 3D geometrical for at least a portion of the venue built using perception sensor data obtained by the additional portable device. As will be appreciated, these techniques can therefore be extended to employ any number of portable devices, each of which gathers perception sensor data for at least a portion of the venue.

As will be discussed in further detail below, some of the operations involved in employing the techniques of this disclosure may be performed by offline processing resources so that one or more of the 3D geometrical maps for the venue built by the portable devices may be further improved. For example, correcting each subset of the spatially related zones, aggregating corrected subsets and/or performing a geodetic correction of the aggregate transformations may be implemented using offline processing. Examples include building the 3D geometrical map to provide at least one visual marker for at least one component of the 3D geometrical map. These components may be subsets of zones and/or aggregates of zone subsets. Likewise, these components may also be structures, such as the primary structure, the secondary structures and/or the connectors discussed above. Corrections may be applied to different aggregates of subsets of spatially related zones for geometric consistency. Further, the offline processing may involve deletion of at least one of the spatially related zones. Remapping may be performed after deletion and reconstruction may be performed after deletion. Remapping refers to the building of structures, such as the primary structure, the secondary structures of the connectors. Reconstruction may occur after remapping to re-apply the corrections and reconstruct the 3D geometrical map to accommodate the changes associated with remapping.

Accordingly, it will be appreciated that this disclosure relates to a method for building a map for a venue encompassing at least one portable device conveyed by a user using perception sensor data from the portable device that is scalable to accommodate any complexity of the venue and is configured to be operable for limited resources of the at least one portable device. Motion sensor data may be obtained from a sensor assembly of the portable device. Perception sensor data is also obtained for the portable device. A navigation solution is generated and a 3D geometrical map is built for the venue using perception sensor data based at least in part on the navigation solution. Building the map at least partially compensates for sensor drift, accommodates the limited resources of the at least one portable device and provides scalability despite the complexity of the venue by building individual 3D maps for zones. Subsets of the spatially related zones are corrected and the correction is propagated to each zone in the subset so that each 3D map of the zones in each subset are corrected. Corrected subsets are aggregated and corrected by forming a plurality of aggregate transformations followed by correcting each 3D map of the zones in each subset of the aggregate of subsets. A geodetic correction of the aggregated corrected subsets is performed along with geodetically correcting the 3D maps of the zones in each subset in the aggregate of subsets.

In one aspect, the method provides further scalability despite the complexity of the venue for more complex venues, while still accommodating the limited resources of the at least one portable device and while further improving the compensation for sensor drift, wherein the sensor drifts grow larger for the more complex venue, wherein such furthering of capabilities of the method is provided through the method further comprising identifying a primary structure linking spatially related zones and identifying at least one secondary structure related to the primary wherein each secondary structure links spatially related zones. Further, at least one connector may be identified that relates to at least two of the secondary structures related to the primary structure such that each connector links spatially related zones.

In one aspect, the primary structure may be an aggregate of subsets of spatially related zones and each secondary structure may be an aggregate of subsets of spatially related zones. Each connector also may be an aggregate of subsets of spatially related zones.

In one aspect, at least one additional portable device conveyed by another user may be provided, such that motion sensor data may be obtained from a sensor assembly of the at least one additional portable device, perception sensor data may be obtained from at least one perception sensor for the at least one additional portable device, a navigation solution may be generated for the at least one additional portable device based at least in part on the obtained motion sensor data and at least one partial 3D geometrical map for at least a portion of the venue is built using the perception sensor data from the at least one additional portable device obtained from the at least a portion of the venue, based at least in part on the navigation solution generated for the at least one additional portable device and corrected zones, corrected subsets of zones and corrected aggregated subsets of zones. The 3D geometrical map for the venue may be built based on a partial 3D geometrical map for at least a portion of the venue using perception sensor data obtained by the at least one portable device and corrected zones, corrected subsets of zones and corrected aggregated subsets of zones and on at least a partial 3D geometrical map for at least another portion of the venue using perception sensor data obtained by the at least one additional portable device and different corrected zones, corrected subsets of zones and corrected aggregated subsets of zones. Further, the 3D geometrical map for the venue may be built based at least in part on perception sensor data for each of the portable devices. The perception sensor data for each of the portable devices may also be obtained asynchronously.

In one aspect, of the method may also involve further improving the 3D geometrical map for the venue using an offline processing resource. For example, the offline processing resource may be further operative to perform any one or any combination of correction of zones, correction of subsets of zones, correction of aggregated subsets of zones and performing geodetic corrections of the aggregated corrected subsets. The offline processing resource may be further operative to provide at least one visual marker for at least one component of the 3D geometrical map. The offline processing resource may be further operative to enable spatial selection. The offline processing resource may also be further operative to enable deletion of at least one of the spatially related zones, to enable deletion of at least one subset of the spatially related zones and/or to enable deletion of at least one aggregate of subsets of the spatially related zones. Additionally, the offline processing resource may be further operative to enable remapping following deletion of at least one of the spatially related zones and performing at least one reconstruction following remapping to preserve structural integrity.

In one aspect, the at least one perception sensor may be at least one of an optical camera, lidar, a thermal camera, an IR camera, radar and an ultrasonic sensor. For example, the at least one perception sensor may be at least one lidar that outputs lidar measurements for the portable device.

In one aspect, a position for a device within the venue may be determined based at least in part on the built map. Determining the position for the device may involve applying a sequence of corrections derived from the plurality of aggregate transformations for the aggregated corrected subsets.

Further, this disclosure also includes a system for building a map for area venue encompassing at least one portable device conveyed by a user using perception sensor data from the portable device. As with the method, the system is scalable to accommodate any complexity of the venue and the system is configured to be operable for limited resources of the at least one portable device. The system may include at least one portable device having a sensor assembly configured to output motion sensor data, at least one perception sensor providing perception sensor data for the at least one portable device and at least one processor, coupled to receive the motion sensor data, the perception sensor data. Further, the at least one processor may be operative to obtain motion sensor data from a sensor assembly of the at least one portable device, obtain perception sensor data from at least one perception sensor for the at least one portable device, generate a navigation solution for the at least one portable device based at least in part on the obtained motion sensor data and build a 3D geometrical map for the venue using perception sensor data based at least in part on the navigation solution. Notably, building the map at least partially compensates for sensor drift, accommodates the limited resources of the at least one portable device and provides scalability despite the complexity of the venue by building individual 3D maps for zones, wherein the zones are spatially related and each zone is a partition of the venue, for a subset of zones, wherein each subset comprises a same number of spatially related zones that are contiguous with each other, correcting each subset of the spatially related zones and propagating the correction to each zone in the subset and correcting each 3D map of the zones in each subset, aggregating corrected subsets and correcting the aggregated corrected subsets by forming a plurality of aggregate transformations followed by correcting each 3D map of the zones in each subset of the aggregate of subsets and performing a geodetic correction of the aggregated corrected subsets and geodetically correcting the 3D maps of the zones in each subset in the aggregate of subsets.

In one aspect, the at least one processor may be operative to provide further scalability despite the complexity of the venue for more complex venues, while still accommodating the limited resources of the at least one portable device and while further improving the compensation for sensor drift, wherein the sensor drifts grow larger for the more complex venue, wherein such furthering of capabilities of the system is provided through the at least one processor being further operative to identify a primary structure linking spatially related zones and to identify at least one secondary structure related to the primary structure, wherein each secondary structure links spatially related zones Further, at least one connector may be identified that relates to at least two of the secondary structures related to the primary structure such that each connector links spatially related zones. In one aspect, the primary structure may be an aggregate of subsets of spatially related zones and each secondary structure may be an aggregate of subsets of spatially related zones. Each connector also may be an aggregate of subsets of spatially related zones.

In one aspect, the system may also include at least one additional portable device conveyed by another user may be provided, such that motion sensor data may be obtained from a sensor assembly of the at least one additional portable device, perception sensor data may be obtained from at least one perception sensor for the at least one additional portable device, a navigation solution may be generated for the at least one additional portable device based at least in part on the obtained motion sensor data and at least one partial 3D geometrical map for at least a portion of the venue is built using the perception sensor data from the at least one additional portable device obtained from the at least a portion of the venue, based at least in part on the navigation solution generated for the at least one additional portable device and corrected zones, corrected subsets of zones and corrected aggregated subsets of zones. The 3D geometrical map for the venue may be built based on a partial 3D geometrical map for at least a portion of the venue using perception sensor data obtained by the at least one portable device and corrected zones, corrected subsets of zones and corrected aggregated subsets of zones and on at least a partial 3D geometrical for at least another portion of the venue built using perception sensor data obtained by the at least one additional portable device and different corrected zones, corrected subsets of zones and corrected aggregated subsets of zones. Further, the 3D geometrical map for the venue may be built based at least in part on perception sensor data for each of the portable devices. The perception sensor data for each of the portable devices may also be obtained asynchronously.

In one aspect, the system may also include an offline processing resource such that the offline processing resource is operative to improve the 3D geometrical map for the venue. For example, the offline processing resource may be operative to perform at least one of correction of zones, correction of subsets of zones, correction of aggregated subsets of zones and geodetic corrections of the aggregated corrected subsets.

In one aspect, the offline processing resource may also be further operative to provide at least one visual marker for at least one component of the 3D geometrical map; to enable spatial selection; to enable deletion of at least one of the spatially related zones; to enable deletion of at least one subset of the spatially related zones; to enable deletion of at least one aggregate of subsets of the spatially related zones; and/or to enable remapping following deletion of at least one of the spatially related zones and subsequently to perform at least one reconstruction following remapping to preserve structural integrity

In one aspect, the at least one perception sensor may be at least one of an optical camera, lidar, a thermal camera, an IR camera, radar and an ultrasonic sensor. For example, the at least one perception sensor may be at least one lidar that outputs lidar measurements for the portable device.

In one aspect, the at least one processor may be operative to determine a position for a device within the venue based at least in part on the built map. Determining the position for the device may involve applying a sequence of corrections derived from the plurality of aggregate transformations for the aggregated corrected subsets.

### EXAMPLES

It is contemplated that the present methods and systems may be used for any application involving 3D map building for a venue, for example using a process of zone partitioning during creation of scalable 3D maps. In conjunction with zone partitioning, comprehensive a multi-level correction framework may be configured to enhance the accuracy, scalability, and reliability of 3D map construction, such as four levels as discussed herein. Without any limitation to the foregoing, the present disclosure is further described by way of the following examples.

### 1 Partitioning and Scaling

### 1.1 Zones

To address the core challenge of constructing scalable 3D maps within the constraints of limited resources that may be available to a portable device being conveyed by a user, this disclosure includes a partitioning strategy that segments large 3D environments into discrete zones.

Notably, existing portable devices having LiDAR/optical-based sensors, or other perception sensors as discussed above, have limitations that inhibit the construction of scalable 3D maps, and the techniques of this disclosure compensate of such limitations. For example, a zone-based partitioning strategy that divides the 3D environment into discrete zones, each assigned a 3D transformation matrix that serves as the foundation for the multi-level correction framework. This approach not only addresses resource constraints but also ensures scalability and precision in constructing large and complex 3D maps.

The size and detail of each zone may be dictated by the perception sensor hardware capabilities and sensors used. Portable devices with limited resources, such as lower memory or processing power, may save smaller zones, while more capable hardware may generate larger zones with greater detail. However, the actual size of the zones is not the critical factor; instead, their accurate representation in 3D space is paramount. By preserving the spatial relationships of zones within the map, this strategy ensures that zones can be accurately stitched together, creating a cohesive and reliable 3D map.

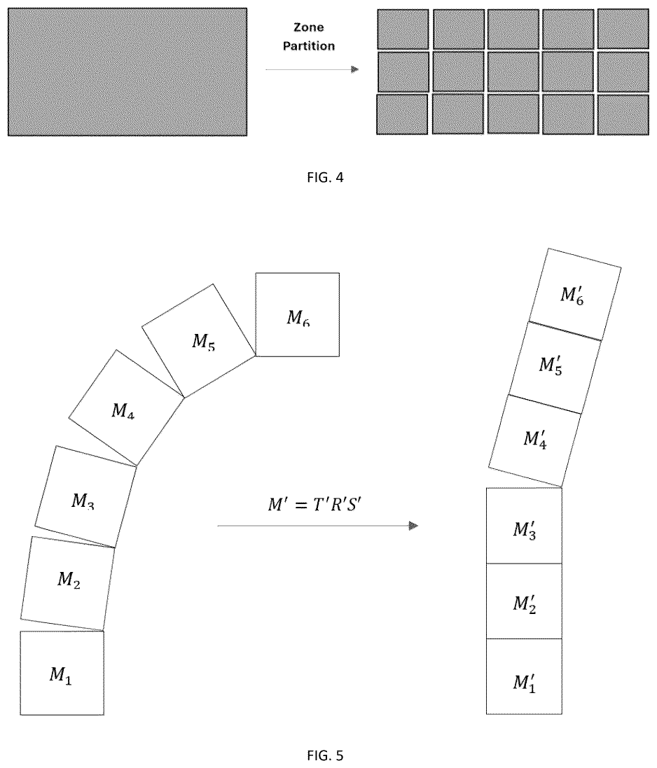

This partitioning strategy provides flexibility in managing varying hardware capabilities without compromising the quality of the map. Whether the zones are small or large, the methodology ensures that each zone integrates seamlessly into the overall 3D environment. As a result, even portable devices with limited resources can contribute to the construction of expansive, scalable 3D maps in an efficient and resource-optimized manner. This adaptability makes the system robust and widely applicable across a range of portable devices, supporting the creation of detailed 3D maps regardless of hardware constraints. For example, FIG. 4 schematically depicts in the left side view an arbitrary 3D environment (not necessarily rectangular despite the example shown) that the portable device may map. Given the limited resources of the portable device, advanced algorithms are employed to automatically partition the environment into zones, as shown on the right-hand side. The size and level of detail of each zone may be dynamically determined based on the device's available resources. These zones then serve as the foundational units for the application of the multi-level correction framework.

### 1.2 Transforms

Once the 3D map is divided into zones, each must be uniquely identified for use in the multi-level correction framework (that will be described in the next sub-section). This is achieved by assigning a distinct 3D transform—represented by a 4×4 matrix—to each zone. Each transform comprises a 3D position (x, y, z), a 3D rotation (roll, pitch, yaw), and a scale defined by a 3D scalar vector (typically set to 1 for uniform scaling). Next, zones are grouped into subsets, so that each collection of zones, for example, three zones (for illustration purposes, but subsets may be employ other fixed numbers of zones as desired) share a common local coordinate system. This approach leverages their inherent similarities to build a cohesive and scalable 3D map.

### 1.3 Multi-Level Correction

The techniques of this disclosure may employ a multi-level correction framework designed to enhance the accuracy, scalability, and reliability of 3D map construction. As one embodiment, a four-level correction according to the techniques of this disclosure may first involve a linear interpolation of local 3D transformation matrices. The initial level involves the application of linear interpolation techniques to local 3D transformation matrices. This step ensures smooth transitions between sequential data points captured by the sensors, thereby reducing abrupt changes and initial drift in the local coordinate systems. Next, an aggregate 3D transformation matrix product is defined. The second level builds upon the interpolated local transformations by performing aggregate 3D transformation matrix multiplications. By combining all local 3D transformation matrices, a cohesive and continuous absolute 3D map is constructed. This process integrates individual segments into a unified representation, which serves as the foundation for further corrections. Then, a correction of the aggregate transformations may be performed. Notably, any discrepancies within the aggregate transformations may be addressed and corrected. This involves fine-tuning the combined 3D map to eliminate cumulative errors that may have arisen during the aggregation process. Advanced correction algorithms are applied to ensure the integrity and accuracy of the absolute 3D map. Finally, geodetic correction and coordinate conversion may be performed. In particular, the geodetic correction is crucial for converting all Cartesian coordinates into the geodetic frame. This conversion aligns the 3D map with real-world geographical coordinates, facilitating accurate indoor positioning and navigation. By integrating geodetic corrections, the techniques of this disclosure ensure that the 3D map is not only precise but also geographically relevant.

Overall, this multi-level correction framework effectively mitigates the errors associated with sensor drift and enhances the scalability and usability of the constructed 3D maps. By addressing each level of correction with targeted techniques and algorithms, our solution provides a robust and reliable method for 3D map construction and positioning. Exemplary details for each of these correction levels are described in the following materials, in the context of a four level correction.

### 1.3.1 Linear Interpolation of Local 3D Transformation Matrices

As one example of a first-level correction (Level 1), the portable device constructs a raw 3D map in real-time. As the device traverses through the environment, it periodically saves local zones after a specified distance has been traveled. Each local zone is a subset of the aggregate 3D map and contains both local-space and world-space 3D coordinates, as well as the corresponding transformation matrices. An aggregate map comprises n such zones, each characterized by uncorrected 3D coordinates and world-space transformation matrices.

The process begins by saving and processing every three local zones. Again, the number of zones may be tailored to the capabilities of the portable device(s) being used and any other suitable considerations. Accordingly, the context of the following discussion involves three zones but in other implementations, other numbers of zones may be employed. Once three zones are accumulated, the user may manually align the third-most recent zone to the real-world coordinate system using 3D transformation operations, which include translation T, rotation R specified in terms of yaw, pitch, and roll, and scaling S. Upon alignment, the world transforms of the third-most zone is corrected and designated as the reference or “ground truth.”

This corrected transformation matrix, M₃ is then utilized as the basis for linearly interpolating the transformation matrices of the preceding two zones, M₁ and M₂. The objective is to generate accurate real-world transformation matrices for these zones, denoted as M′₁ and M′₂.

Mathematically, the linear interpolation of arbitrary square matrices is undefined. However, given that a 3D transformation matrix M is a 4×4 matrix composed of translation T, rotation R, and scale S components, the interpolation process involves decomposing M into these constituent components. Each component is then interpolated independently before recomposing them into a new interpolated transformation matrix M′.

To help illustrate, representative decomposition and interpolation steps may include the following:

Translation Component T: Perform linear interpolation on the translation vectors t=(x, y, z) independently:

$${t}^{′} = {t}_{1} + α ( {t}_{3} - {t}_{2} )$$

where α is the interpolation parameter (e.g., α=0.5 for midpoint).

Rotation Component R: Utilize spherical linear interpolation (SLERP) for the quaternion representations q of the rotation matrices to avoid singularities and gimbal lock:

$${q}^{′} = SLERP ( {q}_{1} , {q}_{3} , α )$$

Scale Component S: Perform linear interpolation on the scale vectors s=(sx, sy, sz) independently:

$${s}^{′} = {s}_{1} + α ( {s}_{3} - {s}_{2} )$$

Once the translation, rotation, and scale components are interpolated, the new interpolated transformation matrix M′ is reconstructed by combining these components:

$${M}^{′} = {T}^{′} {R}^{′} {S}^{′}$$

where T′ is the reconstructed interpolated translation matrix, R′ is the reconstructed interpolated rotation and matrix, and S′ is the reconstructed interpolated scale matrix.

This interpolation process is repeated for all groups of three in the aggregate, providing the corrected transformation matrices M′₁ and M′₂, and so forth, which form the basis for next level corrections discussed below.

To help illustrate, FIG. 5. schematically illustrates the linear interpolations process as applied to subsets of three spatially related zones of the venue. As may be seen, the left-hand side illustrates a 2D projection of the uncorrected zones, where the presumed path appears as a straight line with no linear interpolation having been applied at this stage. The right-hand side displays the result after applying linear interpolation to the zone transformation matrices, resulting in a much clearer and more defined straight line.

### 1.3.2 Aggregate 3D Transformation Matrix Product

In this embodiment, the next level of corrections (Level 2) involves performing an aggregate product of all n zones transformation matrices. Since every third zone's transformation matrix is considered the ground truth of reality and the previous two zones are interpolated from it, a running transform Aᵢ is tracked, an intermediate zone transform Tⱼ, an intermediate running transform Iₖ and the current zone's transform Tᵢ, where i∈[0, n-1], j∈[k*g, i-1], k is the integer division of i by g and g is the group size (i.e., g=3).

The algorithm is as follows:

Let n be the total number of zones. We define g=3 as the group size and use a floor division to determine the current group for each zone index i. We can now write our algorithm as the following expression,

$${A}_{i} = {I}_{k} * ( {\prod }_{j = k * g}^{i - 1} {T}_{j} ) * {T}_{i} for i = 0 , 1 , 2 , … , n - 1$$

where k is the integer division of i by g:

$$k = \frac{i}{g}$$

and the product

$${\prod }_{j = k * g}^{i - 1} {T}_{j}$$

represents the product of the transformation matrices within the current group and is considered to be the identity matrix when the range is empty (i.e., i=0).

Correspondingly, the complete expression for i^{th} zone aggregate transform in terms of n is:

$${A}_{i} = \{ \begin{matrix}{I}_{k} * {T}_{i} , & if i = 0 \\ {I}_{k} * ( {\prod }_{j = k * g}^{i - 1} {T}_{j} ) * {T}_{i} , & for 1 \leq i \leq n - 1\end{matrix}$$

As such, the final set of aggregate zone transforms can be expressed as the following:

$$A = \{ {A}_{i} \vert 0 \leq i \leq n - 1 \}$$

The set A represents all the corrected aggregated transforms for each zone. These newly updated transforms are then set to their corresponding zones to be used as the basis for the next level of corrections.

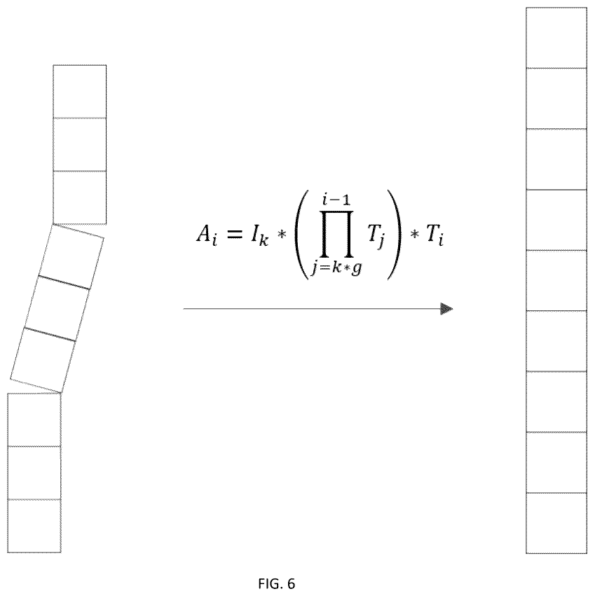

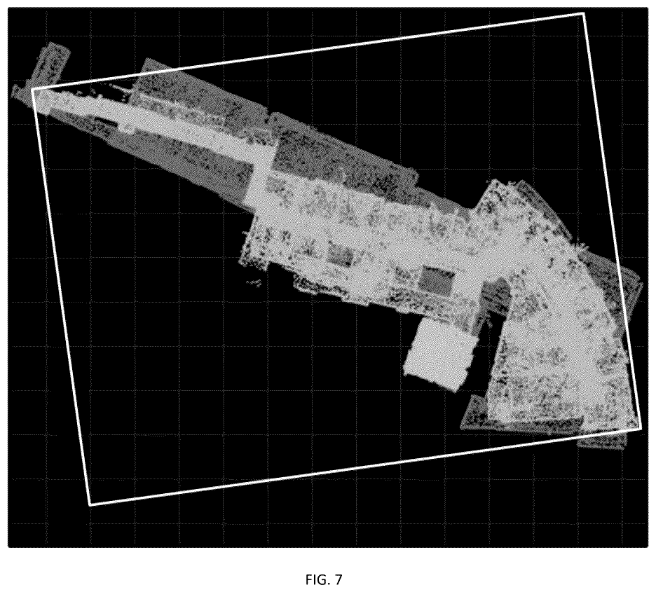

To help illustrate, in FIG. 6 the left-hand side displays the outcome of applying first level corrections to nine zones. The right-hand side illustrates the result after implementing the aggregate transformation matrix algorithm, resulting in a precise straight line.

### 1.3.3 Correction of Aggregate Transformations

The next stage of this embodiment begins with Floor/Area corrections of the aggregate transformations (Level 3), particularly focusing on mitigating any offset or local drift that may occur during the construction of an aggregate. Each floor or area aggregate is relative to a known zone within the Backbone, which serves as a reference framework. When constructing floors or areas, these aggregates align relative to the orientation and position of their corresponding reference zones. This alignment process can introduce some offsets between different floors (e.g., between floor 1 and floor 3) due to starting with different zone alignments.

For instance, consider a scenario where α user is mapping a five-story building, with each floor being treated as an independent aggregate. When viewing the 2D projections of these floors from a top-down perspective, it is possible to observe slight shifts or rotations between the floors. For example, floor 1 and floor 3 may be rotated relative to each other by a few degrees, or floors 4 and 5 might exhibit similar rotational discrepancies. These offsets arise from the differences in the initial zone alignments for each floor.

To correct such aggregate offsets, the techniques of this disclosure allow the user to perform rotational adjustments around the up axis for any of the n floors (aggregates) independently. This adjustment is executed iteratively until all floors or areas are properly aligned with one another. This iterative process is crucial for eliminating any positional or orientational discrepancies that may have been introduced during the initial aggregate construction, ensuring a cohesive and accurately aligned multi-floor 3D map.

Next, this level of corrections involves connector corrections. Connectors are another set of aggregates, similar to floors/areas, that are aligned relative to a specific Floor/Area zone. When a user aligns a zone within a Floor/Area aggregate, they can then construct the corresponding Connector. However, like Floor/Area's, connectors may accumulate offset or drift over time relative to their aligned zones.

Connectors differ from Floor/Area's in that they can be mapped either horizontally or vertically, introducing additional complexity. To address this, different correction methods may be implemented include 3D-Yaw Rotation and Tilt Rotation. For example, 3D-Yaw Rotation is a correction method used to adjust horizontal offsets. By applying a rotational transformation around the vertical (up) axis, the Connector's orientation may be aligned with that of its corresponding Floor/Area. This involves calculating the yaw angle required to minimize the offset between the Connector and the Floor/Area aggregate and applying the rotation to correct the alignment. Further, Tilt Rotation is a correction that addresses vertical offsets and involves adjusting the tilt of the Connector. Tilt rotation corrects any angular discrepancies in the pitch and roll orientations that may have developed over time. By determining the necessary tilt adjustments, the Connector may be realigned to match the vertical orientation of its corresponding Floor zone.

These correction methods are applied iteratively to ensure precise alignment of Connector's with their respective Floor/Areas. The combination of 3D-Yaw Rotation and Tilt Rotation ensures that both horizontal and vertical discrepancies are addressed, maintaining the integrity and accuracy of the overall 3D map.

### Tilt Rotation Details:

Given three non-colinear points P_0, P_1, [symbol] P [symbol] _2∈R\hat{ }3, we will compute the angle θ between vectors (v_1)\vec{ }=P_1−P_0 and (v_2)\vec{ }=P_2−P_0, the rotation vector r\vec{ }∈R\hat{ }3, and define the infinite plane that (v_1)\vec{ } and (v_2)\vec{ } span in R\hat{ }3.

### Computation:

### Angle θ:

$$θ = \text{?} cos \text{?} \hat{} ( - 1 ) ( ( {( v\_ 1 )}^{\to } * {( v\_ 2 )}^{\to } ) / ( // {( v\_ 1 )}^{\to } \text{////} {( v\_ 2 )}^{\to } // ) )$$

where (v_1)\vec{ }*(v_2)\vec{ } is the dot product of (v_1)\vec{ } and (v_2)\vec{ }.
//(v_1)\vec{ }//=√((v_1)\vec{ })*(v_1)\vec{ }) and //(v_2)\vec{ }//=√((v_2)\vec{ }*(v_2)\vec{ }) are the magnitudes of (v_1)\vec{ } and (v_2)\vec{ }, respectively.
   Rotation Vector r\vec{ }:

$${r}^{\to } = ( {( v\_ 1 )}^{\to } \times {( v\_ 2 )}^{\to } ) / ( // {( v\_ 1 )}^{\to } \times {( v\_ 2 )}^{\to } // )$$

where (v_1)\vec{ }×(v_2)\vec{ } is the cross product (v_1)\vec{ } and (v_2)\vec{ }.
//(v_1)\vec{ }×(v_2)\vec{ }// is the magnitude of the cross product.

### Plane Definition:

The vectors (v_1)\vec{ } and (v_2)\vec{ } span the plane in R\hat{ }3.
The normal to this plane given by the rotation vector r\vec{ }.

### \Result:

θ is the angle of rotation around r\vec{ }.

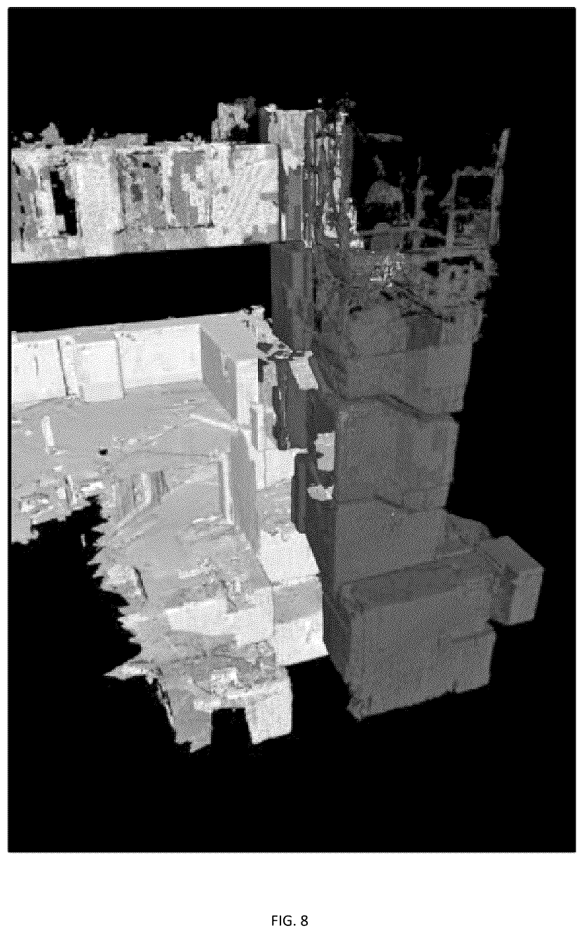

To help illustrate, FIG. 7 shows the process of correcting Floor/Area aggregates. Initially, the two floors are individually aligned, with each maintaining internal consistency due to the first two levels of corrections. However, they are not aligned with each other. To achieve proper alignment, these corrections are applied, ensuring that corresponding sections (e.g., west side corridors and southeast sides) match up accurately in this subsequent level. This alignment is accomplished through a 2D yaw rotation. Further, FIG. 8 schematically depicts the process of correcting Connector aggregates. It highlights the need for a Tilt Rotation on the straight vertical segment. By performing this adjustment, the Connector is accurately positioned, effectively correcting any misalignments. Thus, the method calculates the rotation angle θ and the normalized rotation axis r\vec{ } that the Connector will be rotated around correcting the misalignment. All of these corrections precede the final level correction of this four stage example.

### 1.3.4 Geodetic Correction and Coordinate Conversion

A final correction (Level 4) may involve converting the entire corrected 3D map-comprising both corrected zones and corrected aggregates—from Cartesian coordinates to Geocentric coordinates using a specified origin. This conversion is essential for aligning the constructed map with real-world geographical data.

Once all vertices, faces, and normals are transformed into Geocentric coordinates, we proceed by generating a 2D projection (east-north plane) of the 3D constructed map. This projection is then plotted in geodetic space, serving as a basis for further georeferencing. To accurately align the map with its geographical location, we employ two transformation methods:

Translation of the Origin Position: This transformation allows the user to manually adjust the origin position of the constructed map in geodetic space. By dragging the map, the user can move the origin (initial latitude and longitude) to the desired location, ensuring that the map is correctly georeferenced. This step ensures the positional accuracy of the map relative to the real-world coordinates.

Heading Rotation (East-North Rotation): To correct the orientation of the map, the user applies a heading rotation. This process involves placing two markers on the actual geolocation of the building and two corresponding markers on the 2D projection that match the real-world markers. By creating two lines—each connecting a pair of markers—the angle between these lines may be determined. The map is then rotated by this calculated angle to align the 2D projection with the real georeferenced building.

These transformations are performed iteratively to refine the alignment of the 3D constructed mesh with the actual georeferenced location of the building. Through repeated adjustments, both the positional and orientational discrepancies are minimized, ensuring that the 3D map is accurately aligned with its geographical counterpart.

### Cartesian-Geocentric Conversion Algorithm:

Given a 3D Cartesian point P=(x, y, z), an initial latitude [symbol] φ [symbol] _0 (in degrees) and an initial longitude [symbol] λ [symbol] _0 (in degrees) we can convert the Cartesian coordinates (x, y) to latitude π and longitude λ.

### Constants:

a=637813.0 (semi-major axis of the WGS84 ellipsoid in meters).
e\hat{ }=0.00669437999019758 (eccentricity squared of the WGS84 ellipsoid).

### Steps:

### Convert Initial Latitude to Radians:

$$ϕ\_ 0 \hat{} rad = \text{?} ϕ \text{?} \_ 0 * π / 180$$

### Compute the Radius of Curvature in the Prime Vertical W:

$$W = √ ( 1 - e \hat{} 2 * 〚 sin 〛 \hat{} 2 ( ϕ\_ 0 \hat{} rad ) )$$

### Compute the Radius of Curvature in Meridian M:

$$M = ( a * ( 1 - e \hat{} 2 ) ) / W \hat{} 3$$

### Compute the Radius of Curvature in Prime Vertical N:

$$N = a / W$$

### Compute Changes in Latitude and Longitude in Radians:

$$Δϕ \hat{} rad = x / M$$

$$λ \hat{} rad = y / ( N * cos \text{?} ( ϕ\_ 0 \hat{} rad ) )$$

### Convert Changes in Latitude and Longitude to Degrees:

$$Δϕ \hat{} deg = Δϕ \hat{} rad * 180 / π$$

$$Δλ \hat{} deg = Δλ \hat{} rad * 180 / π$$

### Compute Final Latitude and Longitude:

$$ϕ = \text{?} ϕ \text{?} \_ 0 + Δϕ \hat{} deg$$

$$λ = \text{?} λ \text{?} \_ 0 + Δ \text{?} λ \text{?} \hat{} deg$$

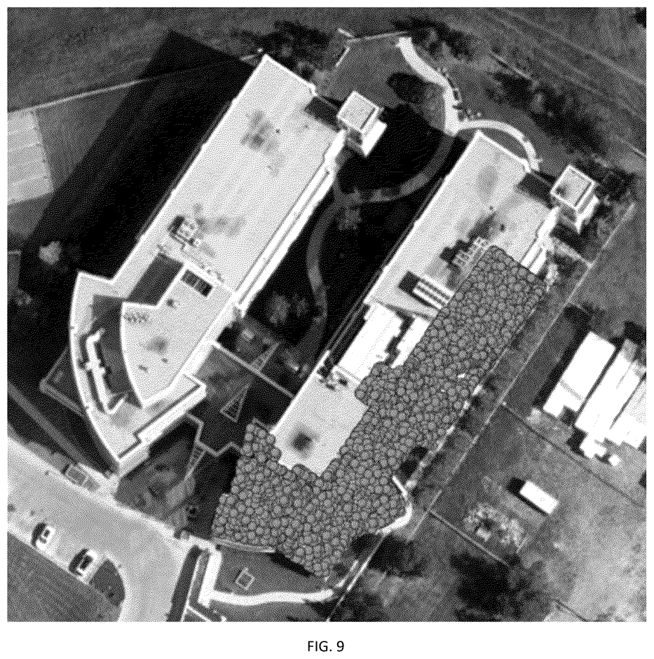

To help illustrate, FIG. 9 shows the conversion process from Cartesian to Geocentric coordinates, as well as the completed alignment of the map to its real-world location. The dots represent a downsampled version of the 2D projection of the building's second floor. The corrections involved both translation and heading adjustments to accurately align the map with the correct georeferenced location.

### 1.4 Mapping Scalability

This disclosure introduces a robust mapping scalability strategy designed to enable the construction of 3D maps that scale seamlessly to any size and shape. The fundamental assumption underlying this strategy is that any arbitrary portable device with perceptions sensors can accurately map small areas or zones with negligible drift. Leveraging this assumption, the strategy ensures scalability across diverse and complex structures.

For context, previous 3D mapping attempts have involved mapping entire 3D structures within a single aggregate, applying only Level 1 and Level 2 corrections to multi-floor structures. While this method proved effective for simple, single-floor layouts with straightforward paths (i.e., minimal walls, corners, or multipath layouts), it became increasingly problematic for more complex, multi-floor structures. The primary issues stemmed from the accumulation of errors and inaccuracies in Level 1 corrections over time, particularly when mapping multi-floor environments. This required users to meticulously plan their path for each floor, as well as their transitions between floors, in one continuous, uninterrupted motion. Such constraints significantly limited the user's ability to strategize the mapping of intricate structures, as they had to maintain a continuous path throughout the mapping process. This approach ultimately failed in environments with dead ends, where users could no longer proceed. Consequently, this disclosure implements a new strategy employing regimented frameworks that facilitate parallel mapping of complex 3D structures, simplifying the initial planning process.

To address these challenges, the layout of a 3D structure may be described in its simplest form, labeling each component and providing context within our solution framework. All 3D structures can be categorized into the following three main formats:
Backbone: The Backbone is a primary structure (or sub-structure) that connects (or has a direct link to) all floors (if multi-floor) and/or areas (if single floor), forming the root for map building. For instance, a central stairwell in a multi-floor building that connects floors 1, 2, 3, etc., serves as the Backbone. In a single-floor structure, such as a warehouse, a horizontal path spanning a significant area and directly linking all other areas in the warehouse functions as the Backbone.
Floor/Area: A Floor/Area is a secondary structure (or sub-structure) that has a direct link or relationship to a zone within the Backbone. The starting zone of a Floor/Area shares the exact same transformation matrix as the Backbone zone it is aligned with. This means that when mapping the Floor/Area, all aggregated zones and their respective transformations are relative to the Backbone zone they are aligned with.
Connector: Similar to a Floor/Area, a Connector is a secondary structure (or sub-structure) that has a direct link or relationship to a zone within a Floor/Area. The starting zone of a Connector shares the same transformation matrix as the Floor/Area zone it is aligned with. Connectors act as terminal components of structures. For example, perimeter stairwells in multi-floor buildings, which connect zones within Floor/Area aggregates, are considered Connectors. Connectors can be mapped both vertically and horizontally, and their corrections are handled accordingly.

### 1.4.1 Backbone

As noted above, the backbone is the foundational component of this embodiment, acting as the root or primary structure upon which all other components are built. Coherent and strategic planning is paramount, as a robust backbone is crucial for constructing a reliable 3D map. The backbone functions similarly to any other aggregate but is meticulously planned to encompass all entry points to a 3D structure. Its shape and path can be arbitrary, allowing for innovative planning and effective risk management during design.

The mapping process begins with the user capturing zones sequentially until a Level 1 correction is necessary (i.e., every three zones). This process continues until the entirety of the backbone is mapped. Upon completion, a 3D render of the backbone is generated, allowing the user to either delete and remap the backbone or select a zone within the backbone to initiate the mapping of a Floor/Area.

The following materials describe various backbone configurations, primarily designed for multi-floor buildings and large single-floor structures such as warehouses:

### 1.4.1.1 Multi-Floor Structures

Multi-floor structures, such as skyscrapers, office buildings, or warehouses, require a specific backbone configuration that enables the construction of maps across all floors. The root of such buildings is typically the central staircase, which spans from the ground floor to the uppermost floor and provides access points to all intermediate floors (e.g., through doors). The backbone in this case is a vertical line that connects all floors. Key considerations when mapping such a backbone include:
a) Confined Spaces: Stairwells are often narrow and confined, necessitating high-quality mapping to account for limited movement space.
b) Anchoring Floors: When transitioning between floors, it is essential to map a small area (e.g., 1×1 m) within each floor by opening the door and scanning the area. This step anchors the backbone to each floor, ensuring that subsequent mapping of the Floor/Area is accurate and properly aligned.
c) Vertical Movement: Level 1 corrections are performed as usual, with the primary difference being the vertical rather than lateral movement.

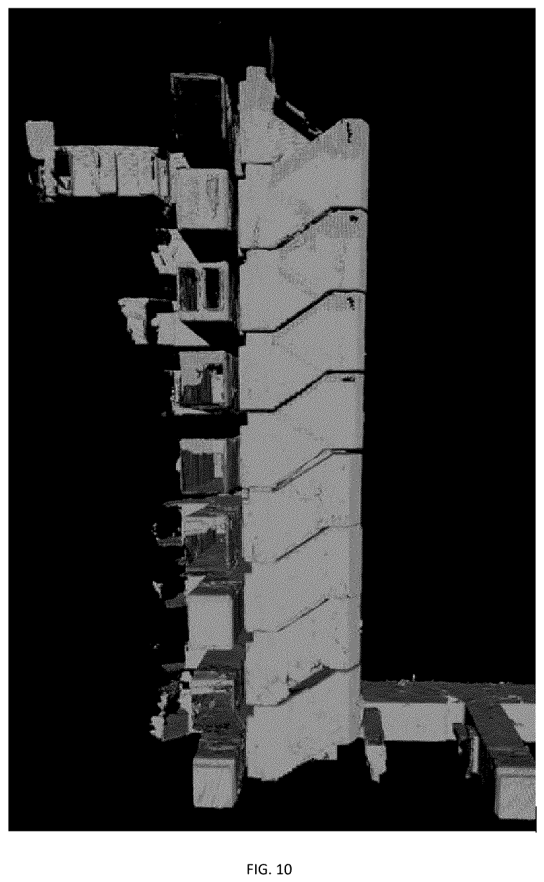

By adhering to these steps, the backbone can effectively span multiple floors without limitation, ensuring that all floors within a multi-floor structure are accessible and mappable. To help illustrate, FIG. 10 schematically illustrates an eight-story vertical Backbone with an additional horizontal section on the first floor. Notably, at each floor transition, a small 1×1 meter area is mapped to ensure that subsequent Floor/Area sub-structures are properly anchored to their corresponding Backbone zones. By applying both Level 1 and Level 2 corrections consistently throughout the process, the resulting Backbone sub-structure is both accurate and scalable, providing a robust foundation for further mapping activities.

### 1.4.1.2 Multi-Floor (Large Floor) Structures

For structures with two or more large floors (e.g., warehouses with double-decker floors), a different backbone strategy may be employed to ensure accessibility to all areas within each floor. A backbone that only spans the central staircase is insufficient, as it complicates the mapping of remaining areas. To address this, a zigzagging backbone may be employed that combines horizontal and vertical sections:
a) Horizontal Sections: The backbone begins with a straight horizontal section on the first floor.
b) Vertical Transition: The backbone then transitions vertically via the staircase to the second floor.
c) Repeated Pattern (Z-Shape Path): This pattern is repeated for all subsequent floors, creating a Z-shaped backbone between two floors.

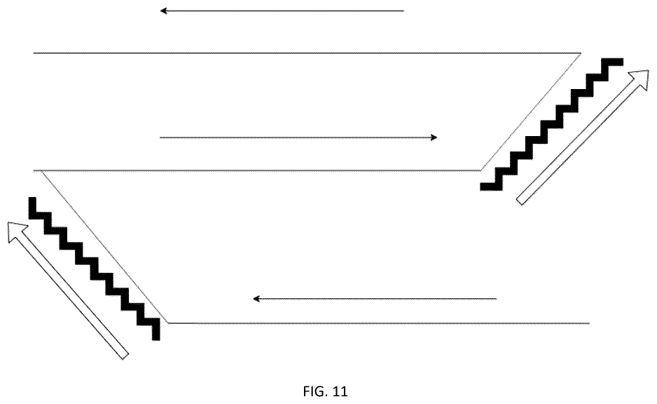

This approach ensures comprehensive coverage of large floors, allowing users to align zones along the horizontal sections of the backbone, facilitating easier mapping of extensive areas within each floor. To help illustrate, FIG. 11 schematically depicts a Z-Shape path used for mapping a Backbone within a multi-floor structure containing large floors. This strategic pattern facilitates the construction of intricate Floor/Area and Connector sub-structure designs. By following this Z-Shape configuration, it ensures comprehensive coverage of all areas within the structure, allowing for scalable and accurate mapping of complex environments. This approach not only enhances the efficiency of the mapping process but also ensures that even the most intricate layouts are thoroughly mapped and integrated into the overall 3D map

### 1.4.1.3 Single-Floor Structures

Designing a backbone for a single-floor structure involves defining a path that ensures all areas are traversable using Floor/Areas and Connectors. The complexity of the floor dictates the specific design choices:
a) Continuous Path: For simpler layouts, a one-time continuous path that reaches all areas is often sufficient. Examples include the main hallway of an office space or the traversable paths in a factory or warehouse.
b) L-Shape and C-Shape Paths: For more regimented layouts, such as warehouses, L-shaped or C-shaped paths are effective. These shapes align with the efficient pathways typically used by employees, minimizing unnecessary movement and optimizing the mapping process.

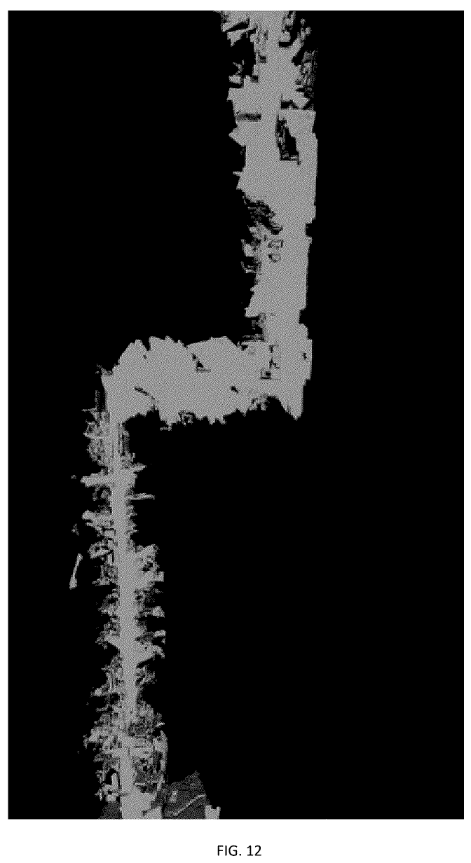

By following these strategies, users can accurately construct backbones for single-floor structures, ensuring comprehensive and reliable mapping. For example, FIG. 12 schematically depicts a horizontal Backbone for a single-floor structure. It combines two L-Shape paths, creating a robust and interconnected mapping framework. This Backbone was implemented in a large single-floor factory. Utilizing the L-Shape path facilitates the mapping of Floor/Area and Connector sub-structures by aligning them within one of the Backbone's zones. This approach allows for a more systematic and efficient method of map construction

### 1.4.1.4 Summary

Ultimately, the design of the backbone is contingent on the specific layout of each building. However, employing these strategies guarantees the creation of effective and robust backbone maps. Once the backbone is mapped, the user can begin aligning zones within the backbone to start mapping the corresponding Floor/Area.

### 1.4.2 Floor/Area

A Floor/Area represents the next critical sub-structure in the mapping hierarchy following the Backbone, and accordingly may be termed a secondary structure. Unlike the Backbone, which is singular, multiple Floor/Area components can be defined as needed. The Backbone is constructed using a series of zones that have undergone Level 1 and Level 2 corrections, ensuring aggregate accuracy. With the Backbone established, the portable device can be aligned to one of the Backbone zones to initiate the mapping of a Floor/Area aggregate.

Consider a multi-floor structure where the central staircase has been mapped as the Backbone. To begin mapping the first floor, the user aligns the portable device with the Backbone zone closest to the first floor and proceeds to map the floor using standard aggregate procedures, including Level 1 corrections every three zones. This process is repeated for each subsequent floor (e.g., floors 2, 3, etc.) until the entire multi-floor structure is mapped.

There are two primary types of Floor/Area components: Floors and Areas. Depending on the context, a Floor/Area component can be viewed as a Floor (e.g., Floor 1, Floor 2, etc.) or as an Area (e.g., multiple areas within a single large floor). Regardless of the context, each Floor/Area component maintains a direct link to a specific zone within the Backbone.

### Floor:

In the context of multi-floor structures, a Floor is defined as an entire floor within the building. For instance, in a skyscraper or office building, the Backbone is typically a vertical structure spanning all floors, with each Floor representing a complete aggregate map of an individual level. Floor 1 corresponds to the aggregate map of the first floor, Floor 2 to the second floor, and so forth. This approach is particularly effective for structures where each floor is uniform and of similar size. It simplifies the mapping process and ensures consistency across floors. For more complex structures, a combination of Floor and Area sub-components may be necessary to capture the intricacies of the layout.

### Area:

In single-floor structures or large open spaces like warehouses, an Area refers to a sub-area within the larger floor. When the Backbone spans the entire floor (e.g., following an L-Shape or C-Shape path), it allows for the mapping of various sub-areas. These sub-areas, or Areas, are mapped based on the zones within the Backbone, which are strategically placed throughout the floor. This approach is used when the structure contains large, open floors that require detailed mapping of sub-sections. By combining these Areas, a comprehensive 3D map of the entire floor can be constructed. This method is particularly useful in environments like warehouses where efficiency and precision are paramount.

### Floor/Area Hybrid:

In more complex structures with multiple large and non-uniform floors, a hybrid approach combining both Floor and Area sub-components is employed. This method allows for the flexible and detailed mapping of each floor, accommodating varying sizes and layouts. To implement this hybrid approach, the Backbone must be designed to facilitate it. The Backbone should follow the Z-Shape configuration described earlier, ensuring that sub-areas within each floor are accessible. In scenarios where the Backbone alone is insufficient, Connectors are utilized to bridge gaps and provide comprehensive coverage.

### Floor Summary:

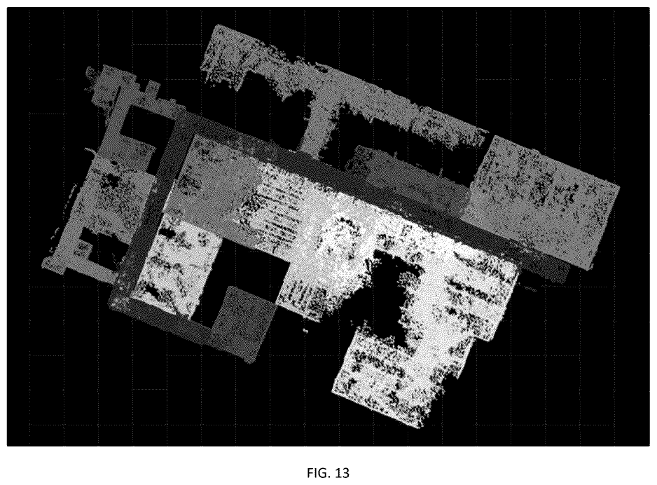

Once all Floor/Area sub-structures are mapped, the user has the option to either delete and remap specific components or proceed with Level 3 corrections on each component. Upon completion of these corrections, the user can choose to finalize the entire 3D map or continue mapping the remainder of the building using Connectors, depending on the structure's requirements. To help illustrate, FIG. 13 schematically illustrates the various Area sub-components that comprise the entire Floor/Area sub-structure. The Backbone, depicted as a long C-Shape path, spans the length of the entire floor. The other sections, highlighted in different shades, represent the Areas aligned from the Backbone and mapped accordingly.

### 1.4.2 Connector

A Connector represents another secondary structure in relation to the primary structure of the Backbone. This may be the final sub-structure in the three-part mapping scalability strategy. Like the Floor/Area sub-structure, Connectors are versatile and can be redefined multiple times as needed. This flexibility allows for the creation of numerous Connectors, akin to how Floor/Area components function. Each Connector maintains a direct link to a zone within a Floor/Area sub-structure, with its initial transformation being relative to one of these zones.

Consider a multi-floor structure where a vertical Backbone and several Floor/Area components have been mapped, and the next step is to begin mapping Connectors. Typically, structures feature multiple stairwells located around the periphery. These stairwells are anchored to specific Floor/Area sub-structures, with entry points that may vary by floor. For instance, a stairwell might have entry points on floor 1 and floor 2. To map the entire stairwell from bottom to top, the process starts by aligning the Connector with the zone in the Floor/Area sub-structure closest to the stairwell entry on the first floor. The mapping proceeds as usual, with Level 1 corrections applied every three zones. This process is repeated for all other stairwells within the structure.

The aforementioned scenario illustrates the mapping of vertical Connectors, which represent the peripheral components of the structure. However, Connectors can be mapped in various shapes and used for different purposes, similar to Backbones and Floor/Area sub-structures. Below are detailed explanations of the two primary types of Connectors used to map complex areas based on specific contexts:

### Vertically Mapped Connectors:

In contexts similar to the one described above, Connectors are mapped vertically, following the same strategy as vertical Backbones. Vertical mapping employs two correction methods: 3D yaw rotation and tilt rotation. These methods are crucial because vertical Connectors span three dimensions. The mapping process includes anchoring and overlapping areas after each floor transition (e.g., by opening doors) to create overlaps between a Floor/Area sub-structure and the corresponding Connector sub-structure. This ensures continuity and accuracy in the vertical alignment.

### Horizontally (Laterally) Mapped Connectors:

In large multi-floor structures with extensive and complex floors, the Backbone is typically created using the Z-Shape strategy, and Floor and Area sub-components are used to map these floors. In cases where certain areas within Floor/Area sub-structures cannot be mapped initially or during initial planning, floors are segmented into a combination of Floor/Area sub-structures and Connector sub-structures. Aligning with a zone within a Floor/Area sub-structure allows the mapping of Connectors to commence. This approach is beneficial for two main reasons:

### Regimented Planning:

It enables a more structured planning process, combining Floor/Area sub-components with Connector sub-structures, reducing the risk of error accumulation and ensuring a more accurate map.

### Flexibility in Mapping:

If any areas are missed during the initial mapping, they can be addressed later using Connectors, as their initial transformation is relative to a Floor/Area sub-structure. This ensures comprehensive coverage and accuracy.

### Combined Vertical and Horizontal Connectors:

For structures with intricate layouts, mapping both vertical and horizontal Connectors is essential. These structures may include external stairwells and horizontal pathways within floors. By integrating both techniques, an accurate 3D map of complex structures can be constructed. For example, this approach eliminates dead ends by considering such areas as Connectors and allowing the mapping to proceed from different zones within Floor/Area sub-structures. Vertical Connectors ensure the accurate alignment of stairwells and other vertical transitions, while horizontal Connectors address extensive lateral areas that may have been missed initially. This combined approach ensures that the entire structure is thoroughly mapped, providing a detailed and precise 3D representation.

### Connector Summary:

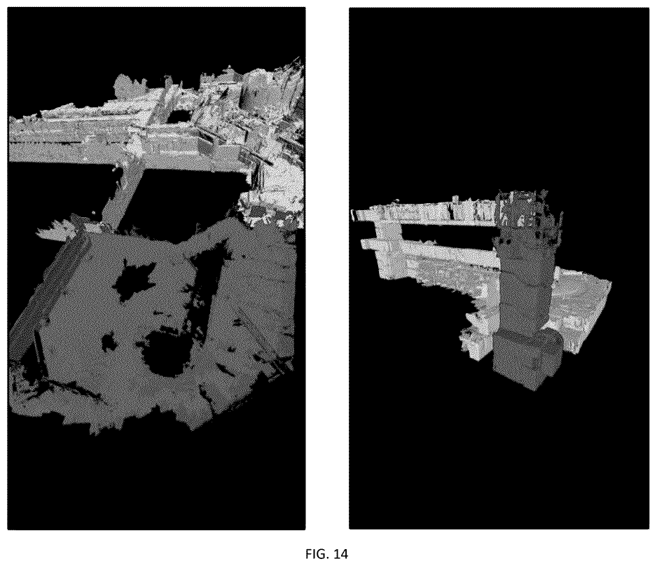

Once all Connector sub-structures are mapped (whether vertically, horizontally, or both), the user can choose to delete and remap any Connectors if necessary or proceed to correct the Connectors using 3D yaw rotation or tilt rotation. After ensuring all Connectors are accurately mapped and corrected, the user finalizes the 3D construction of the entire structure and proceeds to the Cartesian to Geocentric coordinate conversion step. For example, FIG. 14 schematically depicts horizontally and vertically mapped connectors. Specifically, the left image represents a horizontally mapped Connector, while the right image illustrates a vertically mapped Connector. Both configurations are feasible during the mapping process. This flexibility in mapping various shapes and orientations significantly enhances the scalability of constructing detailed 3D maps.

### 1.4.3 Scalability Strategy Summary

The Mapping Scalability Strategy outlined in this disclosure effectively achieves scalability in constructing large and complex 3D maps of indoor environments through its innovative use of Backbone, Floor/Area, and Connector sub-structures. This method addresses the critical challenges of drift, error accumulation, and structural complexity that have historically hindered accurate indoor mapping.

By establishing a strong and strategically planned Backbone, the strategy ensures a stable foundation upon which detailed mapping can be built. The subsequent mapping of Floor/Area components allows for the flexible and precise capture of individual floors or sub-areas, maintaining alignment and accuracy through their direct links to the Backbone. Finally, the use of Connectors bridges any gaps between Floor/Area components, ensuring comprehensive coverage and correction of any missed areas.

This cohesive approach allows for the construction of highly accurate, scalable, and detailed 3D maps, capable of supporting a wide range of applications from indoor navigation to autonomous robotics and augmented reality. The strategic division of the mapping process into these three interconnected components not only enhances the accuracy and usability of the maps but also provides a robust framework for future advancements in indoor mapping technologies.

Overall, the Mapping Scalability Strategy represents a significant step forward in the ability to map large and complex indoor environments, providing a reliable and scalable solution that meets the demands of modern applications and sets a new standard for the industry.

### 1.5 Multi-User Parallel Mapping

Employing the tree-like Backbone mapping scalability techniques of this disclosure allows the capability to construct accurate and scalable 3D maps. The regimented and intricate design of this strategy allows for multi-user parallel mapping, significantly reducing the time required to map extensive 3D structures such as skyscrapers, office buildings, and warehouses by a factor of ten. Without parallelism, an individual mapper would need to map every sub-structure and sub-component (i.e., Backbone, Floor/Area, and Connector) independently, greatly increasing the time and effort involved.

In this section, the strategic breakdown of sub-structures and sub-components that enable multiple users to map simultaneously is detailed. How users can concurrently map Floor/Area and Connector sub-structures and the methods used to synchronize data between all portable devices once all sub-structures are completed by their respective users are also explained. Choosing the protocol to communicate between portable devices is important. Any protocol will suffice and is not limited to one unique protocol. In this disclosure, two main protocols used for the demonstration purpose are discussed in an exemplary manner for illustration, namely TCP/IP and P2P.

### TCP/IP Communication:

The primary method of device-to-device communication is TCP/IP. This method is favored due to its reliable and fast transfer speeds, which are crucial when transferring large volumes of 3D mapping data. The data transferred includes transformation matrices, vertices, normals, and faces, often amounting to gigabytes. Ensuring a fast and reliable communication protocol is vital for efficiency when mapping large 3D structures.

In this method, one mapper is designated as the master, and all other mappers are considered peers (slaves). The master portable device initiates a local hotspot, creating its own local subnet with a corresponding gateway IPv4 address using either cellular or Wi-Fi networks. When the master needs to send mapping data to its peers, it establishes a handshake with each peer on the same subnet and transfers the data sequentially. Similarly, peers can send data to the master by establishing a handshake with the master's IP address and then transferring the mapping data (e.g., Floor/Area, Connector) directly to the master.

This method requires a stable and reliable internet connection (via cellular or Wi-Fi) to function effectively. The direct handshake relationship between devices ensures proper handling and transfer of data. By meeting these requirements, TCP/IP proves to be the optimal solution for transmitting large amounts of 3D data efficiently, significantly reducing the overall time needed to complete the 3D construction of an entire structure.

### P2P Communication:

The second method of device-to-device communication is P2P (Peer-to-Peer). Although slower than TCP/IP, this method does not require a stable internet connection, as it uses technologies such as Bluetooth and Wi-Fi Direct to transfer mapping data between devices. The setup for P2P communication is simpler, as it does not require a handshake to initiate the transfer. Despite being up to five times slower than TCP/IP, depending on the complexity of the 3D data, P2P is advantageous in environments where internet access is unavailable, ensuring continuous data transfer capabilities.

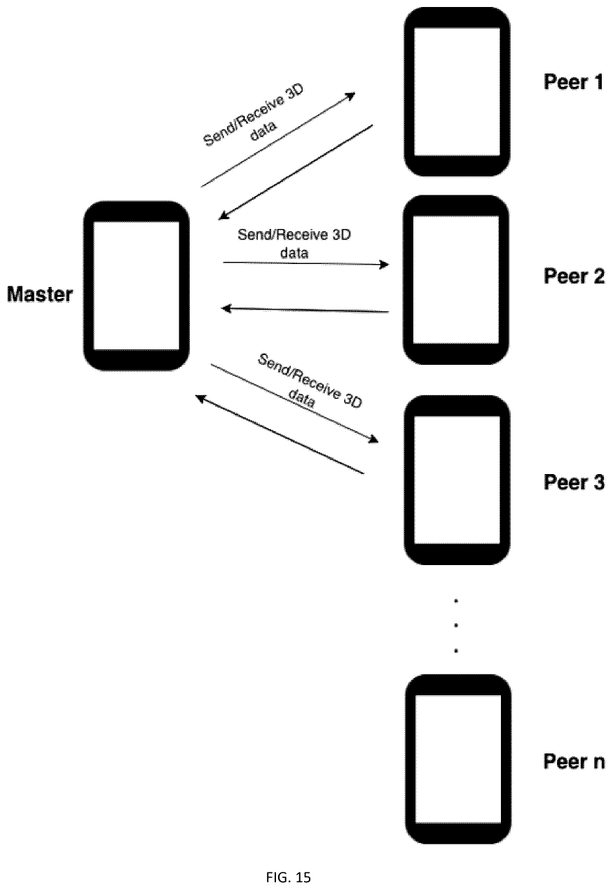

In P2P communication, one mapper is again designated as the master, with all other portable devices as peers (slaves). The master identifies peers by their text names (e.g., peer 1) and sends data directly without a handshake. Peers can similarly send mapping data to the master by identifying the master and transmitting their data. While slower, this method is easier to set up and guaranteed to function even in the absence of cellular or Wi-Fi connectivity, provided the portable devices are equipped with Bluetooth receivers. As one illustration, FIG. 15 schematically depicts a scenario in which the master portable device transmits 3D mapping data (e.g., Backbone, Floor/Area corrections, and Connector corrections) to each peer sequentially. It also shows that peers can send their respective sub-components back to the master, as indicated by the bidirectional arrows representing two-way communication.

### 1.5.1 Parallel Mapping Process

Using either of the two communication protocols described above or any other suitable alternative, a process of multi-user parallel mapping is now described. The tree-like Backbone structure allows for the division of the mapping task into manageable sub-structures and sub-components, which can be assigned to different mappers. This enables multiple users to map various parts of a large 3D structure simultaneously.

### Assigning Sub-Structures:

The mapping task is divided into distinct sub-structures (Backbone, Floor/Area, Connector). Each sub-structure is assigned to a different mapper. The Backbone must be done independently and is done so by the master. Since the Backbone is vital for the accuracy of the entire 3D map, the master maps the Backbone alone. All other users will be assigned a Floor/Area sub-structure as well as Connector sub-structures.

### Concurrent Mapping:

Using the designated communication protocol (TCP/IP or P2P), each mapper works on their assigned sub-structure concurrently. They perform Level 1 corrections every three zones to ensure accuracy and consistency.

### Data Synchronization:

Once all sub-structures are mapped, the data from each portable device is synchronized. The master portable device collects the mapping data from all peers, ensuring that all transformation matrices, vertices, normals, and faces are correctly integrated into a cohesive 3D map.

### Final Integration:

After synchronization, the data is merged to form a complete and accurate 3D representation of the entire structure. This integrated map reflects the contributions of all mappers, providing a comprehensive view of the environment.

### Parallel Mapping Process Summary:

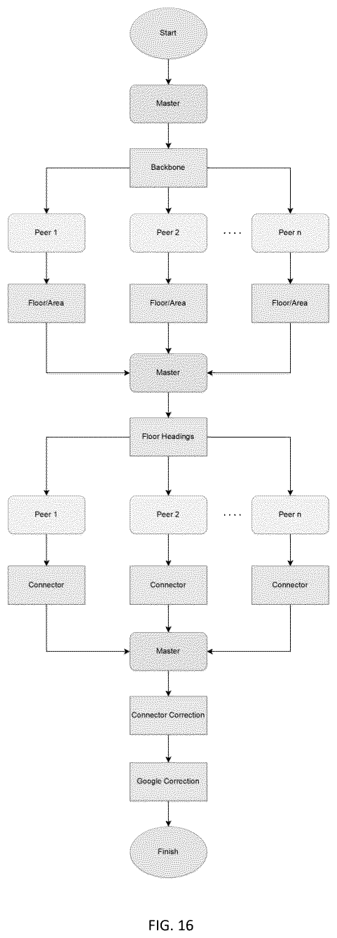

To help illustrate these techniques, FIG. 16 schematically illustrates an exemplary pipeline used for a suitable multi-user parallel mapping technique. Following a divide and conquer strategy that is multi-purpose and multi-functional, this pipeline shows the steps taken to achieve a seamless parallelized mapping experience. The following material describe the above steps in more detail.

### 1.5.1.1 Assigning Sub-Structures & Concurrent Mapping

In embodiments implementing multi-user parallel mapping strategy, the process may begin with the assignment of sub-structures and the concurrent mapping of these components. The initial task of constructing the Backbone is exclusively assigned to the master portable device. This is crucial as the Backbone is the foundational sub-structure upon which all other components depend. The master portable device performs Level 1 corrections (i.e., every three zone corrections) meticulously until the Backbone is fully mapped. Ensuring the Backbone is accurately constructed is paramount since it serves as the reference framework for the entire 3D map.

Once the Backbone is complete, the master portable device disseminates a deep copy of the Backbone—comprising all transformation matrices, vertices, normals, faces, etc.—to all peer portable devices. This allows each peer, as well as the master, to select a unique zone from the Backbone and commence mapping their assigned Floor/Area sub-structures. The assignment of these sub-structures is coordinated by the master portable device, which allocates specific floors or areas to each peer. For instance, in a large vertical building with multiple floors, each peer (and the master) is assigned a distinct floor. If the number of floors exceeds the number of available peers, floors can be distributed accordingly, with peers potentially mapping multiple floors.

To avoid conflicts, it is crucial that each peer maps a unique Floor/Area sub-structure. Mapping the same sub-structure by different peers would result in conflicts during data synchronization, requiring the master to resolve the issue by either selecting one version or deleting both and remapping.

Once all peers, including the master, have completed their respective Floor/Area sub-structures, the synchronization process begins. Each peer transfers their mapped data to the master portable device using either TCP/IP or P2P protocols. The master then integrates all Floor/Area sub-structures and performs Level 3 heading corrections to address any potential errors that may have occurred during the mapping process.

After the master has applied the necessary corrections, the updated Floor/Area sub-structures are redistributed to the peers, who then begin mapping the Connector sub-structures. Similar to the previous phase, each peer is assigned a unique Connector sub-structure to map, starting from a zone within a Floor/Area sub-structure.

Upon completion of the Connector mapping, peers send their respective data back to the master portable device. Conflicts at this stage are handled differently; the master verifies the 3D integrity and uniqueness of each Connector. If no conflicts are detected, the master performs corrections on each Connector using both 3D yaw rotation and tilt rotation methods.

Finally, after all corrections are made, the master can either proceed with additional mapping of Connectors, delete and remap any necessary Connectors, or move on to the final step Level 4 corrections. This step involves georeferencing the entire 3D structure, aligning it accurately with real-world geographical coordinates.

In summary, the process may involve constructing the Backbone with a master portable device using meticulous Level 1 corrections with a deep copy of the Backbone distributed to all peers. A following stage of Floor/Area mapping may involve the master portable device assigning specific floors/areas to peers. Each peer maps their assigned sub-structures with Level 1 corrections. Next, data synchronization with the master is performed using TCP/IP or P2P protocols, or any other suitable communication configuration. Then, the master portable device performs Level 3 heading corrections on integrated Floor/Area sub-structures. A connector mapping operation is then performed to distribute updated Floor/Area sub-structures to peers. Correspondingly, each peer maps their assigned Connector sub-structures and data is sent back to the master for verification and correction. The master portable device may then perform Level 3 corrections on integrated Connector sub-structures. Ultimately, the master portable device is configured to perform final corrections on Connectors. Then, the master portable device may proceed to Level 4 georeferencing, aligning the entire 3D structure with geographical coordinates.

### 1.5.2 Data Synchronization

The process of merging and synchronizing data at the end of each mapping section is crucial for the success of the multi-user parallel mapping strategy. After all peers have completed their respective sub-structures, each peer must sequentially transmit their mapped data to the master portable device. There are two primary outcomes for this data transfer: either the transfer is successful with no conflicts, or the transfer is successful, but conflicts are detected within the Floor/Area or Connector sub-structures. If the transfer is successful and no conflicts are found, the process continues smoothly, and the next peer's data is obtained. However, if conflicts are detected, they must be resolved meticulously to maintain the integrity of the 3D map. Conflict resolution procedures differ based on whether the conflicts occur in Floor/Area sub-structures or Connector sub-structures.

### Floor/Area Conflicts:

Each Floor sub-component is assigned a unique integer identification number, and each Area sub-component is sub-referenced via the Floor sub-component's identification number. For instance, the Floor sub-component for floor 1 is assigned the identifier 1, mapped to a text label such as “F1.” If there are three Area sub-components within floor 1, they would be uniquely identified as “F1_1,” “F1_2,” and “F1_3,” respectively.

Conflicts arise when two or more peers map the same Floor sub-component, the same Area sub-component, or the same Floor/Area sub-structure. These conflicts are not detected during the mapping process but are identified during data synchronization. When conflicts occur, the master portable device must review the conflicting Floor/Area sub-components as 3D renders and decide which version to retain and which to discard. If neither version meets the required standards, the master will remove both and instruct the peer to remap the sub-structure. The conflict resolution procedure involves cross-referencing all other mapped Floor/Area sub-structures to check for duplicate ID numbers. If multiple conflicts are found, the master resolves them sequentially to ensure data integrity before proceeding to the next steps.

### Connector Conflicts:

Connectors are relative to zones in Floor/Area sub-structures, but instead of using unique identification numbers, Connectors are evaluated based on their geometric properties. A statistical algorithm analyzes the vertices, normals, and faces of each Connector to determine geometric similarity. If the geometric similarity between two Connectors exceeds 90%, they are flagged as conflicting. For example, if one peer maps a Connector in hallway x and turns right to map hallway y, and another peer maps a different Connector in hallway x and turns right to map hallway y, the algorithm will likely detect a high similarity and flag these Connectors as conflicting.

The resolution process for Connector conflicts is similar to that of Floor/Area sub-structures. A 3D render of the conflicting Connectors, differentiated by colors, is presented to the master, who then decides which version to retain and which to discard. If neither version is satisfactory, the master directs the peer to remap the Connector.

### Summary

Effective data synchronization is critical to the success of the multi-user parallel mapping strategy. By employing robust conflict detection and resolution mechanisms and leveraging both TCP/IP and P2P communication protocols, we ensure that the final 3D map is accurate, consistent, and comprehensive. This meticulous approach to data synchronization not only enhances the efficiency of the mapping process but also sets a high standard for collaborative 3D mapping technologies, enabling the construction of detailed, scalable, and reliable 3D maps of large and complex structures.

### Final Integration:

Upon the successful transfer of all sub-structures and sub-components-namely the Backbone, Floor/Area(s), and Connector(s)—to the master portable device, an intelligent merging process is initiated to integrate these elements into a cohesive and comprehensive 3D map with a unified origin. This step is critical in ensuring that all mapped data is accurately combined to reflect the entirety of the structure within a single coordinate system.

The integration process leverages the relative transformations of each sub-structure. Since each sub-structure is mapped in relation to others (e.g., the initial transform of a sub-structure is relative to a zone in another sub-structure), we can precisely align all elements within the same spatial framework. This method ensures that the final 3D map is not only accurate but also consistent across all mapped regions.

The utilization of parallelism in this mapping strategy significantly enhances the efficiency of constructing large-scale 3D maps. By distributing the mapping tasks across multiple peers and synchronizing their data with the master portable device, we can achieve a comprehensive and detailed map of large structures in a fraction of the time it would take using traditional methods. This innovative approach leverages the strengths of both the hierarchical structure and advanced communication protocols to streamline the mapping process.

### Time Reduction:

The intelligent merging process, combined with parallel data acquisition, drastically reduces the overall time required to map complex structures from days to mere hours. This is particularly beneficial for large-scale projects such as skyscrapers, office buildings, and expansive warehouses. By enabling multiple mappers to work simultaneously on different sub-structures, the strategy optimizes the use of available resources and minimizes downtime. This efficiency translates to significant cost savings and faster project turnaround times, which are critical in industries where time is a crucial factor.

### Scalability:

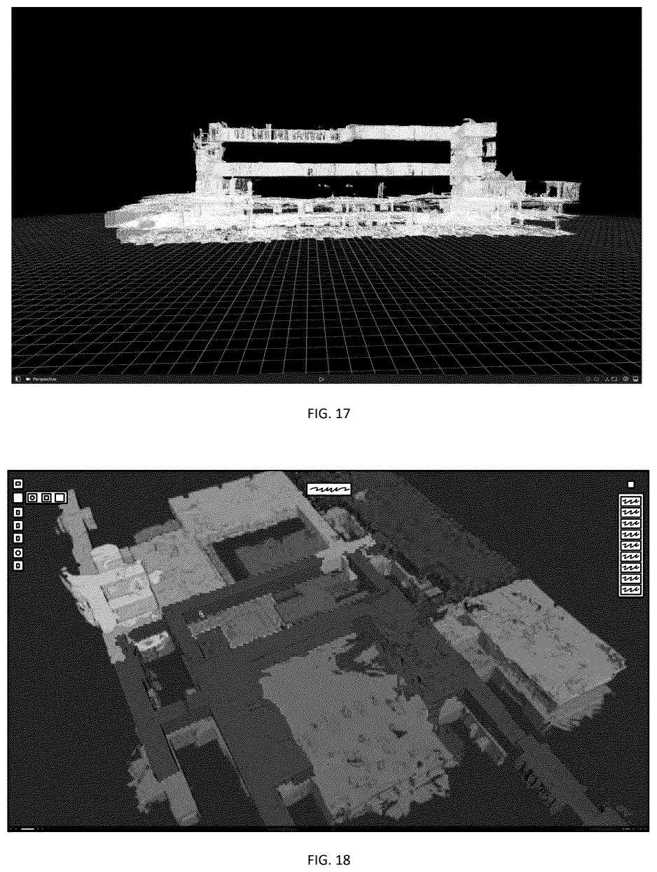

The strategy is inherently scalable, allowing for the addition of more peers to further distribute the workload and expedite the mapping process. This scalability ensures that even the most complex and extensive structures can be mapped efficiently. As the number of peers increases, the mapping task can be divided into smaller, more manageable segments, further enhancing the speed and accuracy of the mapping process. This flexibility makes the system adaptable to various project sizes and complexities, from small single-floor buildings to large multi-floor complexes. To help illustrate, FIG. 17 schematically depicts a final 3D structure, which includes a Backbone, five Floor/Area sub-structures, and one Connector sub-structure in this embodiment. This comprehensive mapping was achieved through multi-user parallelism, with each sub-structure assigned to one of five different peers. By distributing the workload so that each peer was responsible for a single Floor/Area sub-structure, the construction process was both rapid and efficient. This collaborative approach, integrating advanced designs and algorithms, demonstrates the feasibility of constructing large-scale 3D structures with enhanced speed and precision.

### 2 Offline Processing

In recognition of the complexity and critical importance of generating accurate and scalable 3D maps, an advanced offline processer has been developed to address and rectify any discrepancies that may arise during field data collection. This processer enables the ability to manipulate a 3D map with the same precision and methodology used during its initial construction. All algorithms and techniques employed for constructing zones and sub-components in the field are fully integrated into the offline processing environment. Consequently, algorithms are employed that apply Level 1, Level 2, Level 3, and Level 4 corrections post-production, ensuring the integrity and accuracy of the final map.

However, the offline processer is designed with strict adherence to the structural principles of the Backbone Strategy. Actions are not permitted to arbitrarily alter the 3D map; instead, it enforces a set of predefined rules to maintain the structural integrity and coherence of the map. This ensures that any modifications remain consistent with the foundational mapping strategies, preserving the map's accuracy and scalability.

The Offline Processer comprises of multiple components for offline refinement of 3D maps, replicating field-based computational algorithms while enabling precision adjustments through layered methods. For example, the following materials discuss an embodiment employing the four levels of corrections discussed in the materials above.

First, a visualization interface may be employed to provide understanding of the Level 1-Level 3 Corrections. Notably, this may generate interactive representations of zones, zone-triplet hierarchies, and sub-components. Hierarchical elements are differentiated through automatic visual markers, enabling visual analysis of spatial relationships within the 3D model. Next, a spatial selection system implements algorithms matching the Backbone Strategy to manipulate structural elements. Preferably, this supports 3D translations, rotations, and symmetry-based adjustments, mirroring field operations in an offline environment. As will be appreciated, this relates to the Level 1, Level 2 and Level 3 Corrections discussed above. Further, a deletion and reconstruction system may be employed that is configured to fix Level 1-Level 3 Corrections. For example, this may enable removal of zone-triplets (or other suitable numbers of zones employed in the subsets) and/or aggregates while preserving their data parameters. Deleted elements can be reintegrated into the portable device for iterative model rebuilding or expansion. Then, a geodetic alignment system may be employed for the Level 4 Corrections. In particular, this may perform real-time geospatial correction of the 3D model's coordinate framework, aligning with the Level 4 geodetic corrections. Modifications to structural data derived from the perception sensor automatically synchronizes with standardized geodetic coordinates, ensuring positional fidelity during offline editing. Each of these aspects is discussed in detail in the following materials.

### 2.1 Visualization Interface

The system organizes 3D structural elements—including sub-components, zone triplets (or other subsets), and aggregates—using unique visual markers. These markers distinguish elements based on hierarchical relationships and iterative correction phases from Level 1 to Level 3, enabling rapid analysis of spatial 3D data. Navigation controls allow comprehensive examination of zone boundaries, 3D topological linkages, and alignment against 3D spatial data.

A specialized framework translates iterative 3-zone local correction groups into distinct graphical patterns, visually encoding the zone-triplets for analytical validation. Structural sub-components such as backbone elements are prioritized with persistent high-contrast markers, while floor/area sub-components and connector sub-components are differentiated through secondary graphical schemas. This hierarchical distinction identifies inconsistencies by contrasting various 3D patterns across structural levels.

By aligning visual encoding with geometric principles derived from the Backbone Strategy, the system resolves ambiguities in conventional 3D representations. Automated validation protocols audit accuracy and structural coherence, synchronizing correction workflows with real-time visual feedback to ensure fidelity across refinement stages.

To help illustrate, FIG. 18 schematically depicts structural sub-components (aggregates) differentiated by unique visual identifiers. This systematic coding framework enables hierarchical classification and analytical distinction of aggregates/zones within the 3D map.

### 2.2 Spatial Selection System

The system enables hierarchical manipulation of 3D structural elements through four subsystems in the embodiment discussed below, enforcing geometric consistency with the Backbone Strategy while propagating corrections across dependent aggregates. As will be appreciated, these relate to the Level 1, Level 2 and Level 3 corrections discussed above. In other embodiments involving different correction, suitable adjustments may be made.

### Zone Adjustment Protocol:

Modifications to zone-triplet groups are executed via coordinate-space transformations, including rotational and translational adjustments (Level 1 & Level 2). A constraint-based framework ensures all changes comply with the Backbone strategy, while real-time validation protocols dynamically update subsequent zones to reflect Level 1 and Level 2 corrections. Affected downstream elements are visually prioritized for analytical review using tier-based markers.

### Aggregate Relationship Framework:

Structural dependencies between zones and aggregates (sub-components) are managed through a graph-based hierarchy, where connector sub-components and floor/area sub-components are programmatically tagged. A recursive update engine propagates adjustments across parent-child relationships that adhere to Level 3 corrections.

### Composite Aggregate Manipulation:

Entire aggregates-including floor/area and connector sub-components—are adjustable via rotational or tilt-based transformations (Level 3 corrections). The system restricts modifications to the Backbone aggregate, preserving foundational integrity while applying recursive updates to dependent sub-components.

### Structural Safeguard Mechanism:

The Backbone is designated as immutable during aggregate-level operations, ensuring stability across all refinements. Geometric parameters are algorithmically enforced to prevent deviations from predefined protocols.

To help illustrate these techniques, FIG. 19 schematically depicts adjustments to zone-triplet subsets using the system's selection features. Level 1 and 2 corrections are applied here, automatically updating all connected child structures to reflect changes.

### 2.3 Deletion and Reconstruction System

The system enforces hierarchical structural integrity during zone/aggregate removal through constraint-based protocols, preserving foundational frameworks while enabling iterative remapping.

### 2.3.1 Hierarchical Deletion Protocol

When removing zones, deletions are restricted to zone-triplet (or subsets based on other numbers of zones) groups rather than individual zones to prevent destabilization of dependent aggregates. Parent-child dependencies trigger conditional removal workflows: deleting a parent zone-triplet initiates automated validation of downstream aggregates, with options for localized or cascade removal to maintain topological coherence.

### 2.3.2 Structural Dependency Enforcement

When removing aggregates, the deletions follow algorithmic constraints based on interdependent positional relationships. Removal of the first three zones (or the corresponding number when other subsets are employed) in an aggregate mandates full elimination of subsequent dependent zones, as positional references are recursively invalidated. This prevents partial deletions that violate geometric continuity and adhere to the rules of Level 1, Level 2 and Level 3 corrections.

### 2.3.3 Anomaly Identification Subsystem

Elements marked for deletion are flagged using emphasis markers, with distinct graphical indicators differentiating connector sub-components from floor/area sub-components. Automated dependency tracing visualizes hierarchical impacts through tiered emphasis hierarchies.

### 2.3.4 Composite Aggregate Removal Framework

Entire aggregates are removable via recursive graph traversal, eliminating child structures while preserving independent aggregates. A safeguard blocks modifications to the first three zones of the Backbone, ensuring core structural immutability.

### 2.3.5 Core Structural Safeguard

Backbone zones are designated immutable through preservation protocols. Algorithmic locks prevent coordinate modifications or deletions, maintaining integrity for all dependent aggregates.

### 2.3.6 Iterative Reconstruction Protocol

Removed elements retain geospatial metadata for subsequent reintegration. The system enables iterative remapping by reprocessing source perception sensor data against preserved structural anchors, allowing localized corrections without full-system recomputation.

### 2.3.7 Structural Coherence Validation

Post-deletion checks verify alignment fidelity against the Backbone's geometric rules. Automated checks confirm positional continuity in remaining aggregates and validate parent-child reference integrity across the 3D map.

### 2.3.8 Example

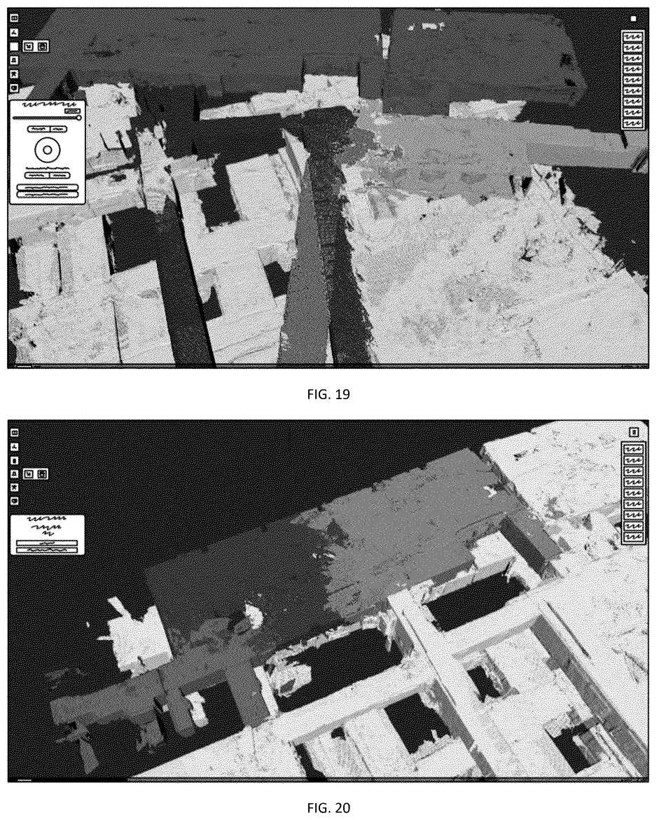

To help illustrate, FIG. 20 schematically depicts the removal of zone subsets, such as triplets in the embodiments discussed above. Each triplet is marked with a unique identifier to clearly show which sections will be deleted.

### 2.4 Geodetic Alignment System

The system aligns 3D structural models with real-world geographic coordinates through automated corrections, corresponding to the Level 4 corrections discussed above, ensuring accuracy between digital maps and physical environments.

Adjustments to the 3D model's position and orientation are made using directional inputs for precise translations and rotations. These corrections align perception sensor-derived models with geographic reference points, fixing minor errors from field data and providing fine tuning.

Moreover, the same alignment methods used during field data collection are applied here, ensuring seamless transitions between on-site work and offline refinement. No retraining is needed, and alignment rules stay consistent across all stages to maintain fieldwork consistency.

As warranted, the system rotates parts of the 3D model around specific pivot points, allowing targeted adjustments to fix misalignments to provide pivot-based corrections. These constraints automatically maintain overall geographic accuracy during changes.

Further, every adjustment to the 3D model may be instantly updated with its geographic coordinates. The system continuously checks alignment accuracy, preventing errors from building up over time.

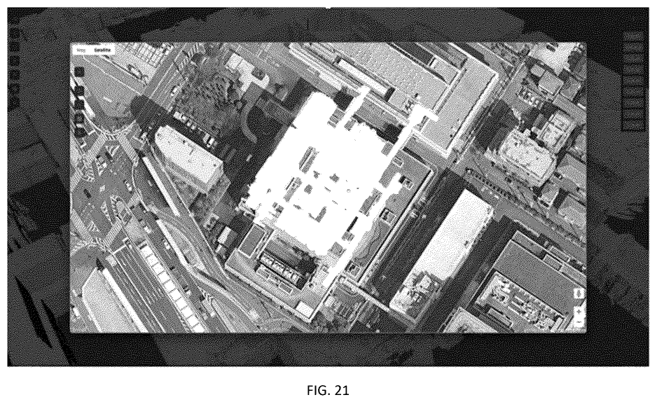

To help illustrate these aspects of the disclosure, FIG. 21 schematically depicts the execution of geodetic alignment and coordinate transformation workflows through integrated input modalities. Rotational and translational operations are coordinated via peripheral command panels and positional tracking mechanisms, producing a geodetically aligned structural model compliant with standardized reference frameworks. Shown is a top down view of a built map indicated in white superimposed over the corresponding portion of the venue.

### 3 Positioning

With the development of 3D mapping and the capability to generate scalable 3D maps, a range of advanced applications and tools can now leverage these maps for precise positioning. Once a 3D map has been constructed, the resulting data can be utilized for accurate positioning within the map. This is achieved by applying the sequence of corrections from the mapping process (i.e., Level 1, Level 2, Level 3, and Level 4) and combining these to derive a corrected 3D position vector.

Given that the entire 3D map is partitioned into sub-components (aggregates), with each aggregate comprising a set of zones, each zone is associated with a transformation matrix inherited from its parent aggregate. This transformation matrix, in conjunction with the corrections applied at Levels 1 through 4, is used to compute the final corrected transformation.

Consider a 3D map consisting of n zones, and suppose we wish to determine the position within zone m, where m∈[1, n] and n, m∈ [symbol] . The following sequence of operations is performed to obtain the corrected position,

Let L₁, L₂, L₃ and L₄ represent the transformation matrices corresponding to the corrections applied at Level 1, Level 2, Level 3, and Level 4, respectively. Let Tm be the transformation matrix associated with zone m. The final corrected transform A is calculated as,

$$A = {L}_{4} * {L}_{3} * {L}_{2} * {L}_{1} * {T}_{m}$$

Thus, the final corrected position of an object within zone m is obtained from the translation component of the transformation matrix A,

$$t = {[ {t}_{x} , {t}_{y} , {t}_{z} ]}^{T}$$

### CONTEMPLATED EMBODIMENTS

The present disclosure describes the body frame to be x forward, y positive towards right side of the body and z axis positive downwards. It is contemplated that any body-frame definition can be used for the application of the method and apparatus described herein.

It is contemplated that the techniques of this disclosure can be used with a navigation solution that may optionally utilize automatic zero velocity periods or static period detection with its possible updates and inertial sensors bias recalculations, non-holonomic updates module, advanced modeling and/or calibration of inertial sensors errors, derivation of possible measurements updates for them from GNSS when appropriate, automatic assessment of GNSS solution quality and detecting degraded performance, automatic switching between loosely and tightly coupled integration schemes, assessment of each visible GNSS satellite when in tightly coupled mode, and finally possibly can be used with a backward smoothing module with any type of backward smoothing technique and either running in post mission or in the background on buffered data within the same mission.

It is further contemplated that techniques of this disclosure can also be used with a mode of conveyance technique or a motion mode detection technique to establish the mode of conveyance. This enables the detection of pedestrian mode among other modes such as for example driving mode. When pedestrian mode is detected, the method presented in this disclosure can be made operational to determine the misalignment between the device and the pedestrian.

It is further contemplated that techniques of this disclosure can also be used with a navigation solution that is further programmed to run, in the background, a routine to simulate artificial outages in the absolute navigational information and estimate the parameters of another instance of the state estimation technique used for the solution in the present navigation module to optimize the accuracy and the consistency of the solution. The accuracy and consistency is assessed by comparing the temporary background solution during the simulated outages to a reference solution. The reference solution may be one of the following examples: the absolute navigational information (e.g. GNSS); the forward integrated navigation solution in the device integrating the available sensors with the absolute navigational information (e.g. GNSS) and possibly with the optional speed or velocity readings; or a backward smoothed integrated navigation solution integrating the available sensors with the absolute navigational information (e.g. GNSS) and possibly with the optional speed or velocity readings. The background processing can run either on the same processor as the forward solution processing or on another processor that can communicate with the first processor and can read the saved data from a shared location. The outcome of the background processing solution can benefit the real-time navigation solution in its future run (i.e. real-time run after the background routine has finished running), for example, by having improved values for the parameters of the forward state estimation technique used for navigation in the present module.

It is further contemplated that the techniques of this disclosure can also be used with a navigation solution that is further integrated with maps (such as street maps, indoor maps or models, or any other environment map or model in cases of applications that have such maps or models available) in addition to the different core use of map information discussed above, and a map matching or model matching routine. Map matching or model matching can further enhance the navigation solution during the absolute navigational information (such as GNSS) degradation or interruption. In the case of model matching, a sensor or a group of sensors that acquire information about the environment can be used such as, for example, Laser range finders, cameras and vision systems, or sonar systems. These new systems can be used either as an extra help to enhance the accuracy of the navigation solution during the absolute navigational information problems (degradation or absence), or they can totally replace the absolute navigational information in some applications.

It is further contemplated that the techniques of this disclosure can also be used with a navigation solution that, when working either in a tightly coupled scheme or a hybrid loosely/tightly coupled option, need not be bound to utilize pseudorange measurements (which are calculated from the code not the carrier phase, thus they are called code-based pseudoranges) and the Doppler measurements (used to get the pseudorange rates). The carrier phase measurement of the GNSS receiver can be used as well, for example: (i) as an alternate way to calculate ranges instead of the code-based pseudoranges, or (ii) to enhance the range calculation by incorporating information from both code-based pseudorange and carrier-phase measurements; such enhancement is the carrier-smoothed pseudorange.

It is further contemplated that the techniques of this disclosure can also be used with a navigation solution that relies on an ultra-tight integration scheme between GNSS receiver and the other sensors' readings.

It is further contemplated that the techniques of this disclosure can also be used with a navigation solution that uses various wireless communication systems that can also be used for positioning and navigation either as an additional aid (which will be more beneficial when GNSS is unavailable) or as a substitute for the GNSS information (e.g. for applications where GNSS is not applicable). Examples of these wireless communication systems used for positioning are, such as, those provided by cellular phone towers and signals, radio signals, digital television signals, WiFi, or Wimax. For example, for cellular phone based applications, an absolute coordinate from cell phone towers and the ranges between the indoor user and the towers may be utilized for positioning, whereby the range might be estimated by different methods among which calculating the time of arrival or the time difference of arrival of the closest cell phone positioning coordinates. A method known as Enhanced Observed Time Difference (E-OTD) can be used to get the known coordinates and range. The standard deviation for the range measurements may depend upon the type of oscillator used in the cell phone, and cell tower timing equipment and the transmission losses. WiFi positioning can be done in a variety of ways that includes but is not limited to time of arrival, time difference of arrival, angles of arrival, received signal strength, and fingerprinting techniques, among others; all of the methods provide different level of accuracies. The wireless communication system used for positioning may use different techniques for modeling the errors in the ranging, angles, or signal strength from wireless signals, and may use different multipath mitigation techniques. All the above mentioned ideas, among others, are also applicable in a similar manner for other wireless positioning techniques based on wireless communications systems.

It is further contemplated that the techniques of this disclosure can also be used with a navigation solution that utilizes aiding information from other moving devices. This aiding information can be used as additional aid (that will be more beneficial when GNSS is unavailable) or as a substitute for the GNSS information (e.g. for applications where GNSS based positioning is not applicable). One example of aiding information from other devices may be relying on wireless communication systems between different devices. The underlying idea is that the devices that have better positioning or navigation solution (for example having GNSS with good availability, accuracy or other aspects indicative of GNSS quality) can help the devices with degraded or unavailable GNSS to get an improved positioning or navigation solution. This help relies on the well-known position of the aiding device(s) and the wireless communication system for positioning the device(s) with degraded or unavailable GNSS. This contemplated variant refers to the one or both circumstance(s) where: (i) the device(s) with degraded or unavailable GNSS utilize the methods described herein and get aiding from other devices and communication system, (ii) the aiding device with GNSS available and thus a good navigation solution utilize the methods described herein. The wireless communication system used for positioning may rely on different communication protocols, and it may rely on different methods, such as for example, time of arrival, time difference of arrival, angles of arrival, and received signal strength, among others. The wireless communication system used for positioning may use different techniques for modeling the errors in the ranging and/or angles from wireless signals, and may use different multipath mitigation techniques.

The embodiments and techniques described above may be implemented in software as various interconnected functional blocks or distinct software modules. This is not necessary, however, and there may be cases where these functional blocks or modules are equivalently aggregated into a single logic device, program or operation with unclear boundaries. In any event, the functional blocks and software modules implementing the embodiments described above, or features of the interface can be implemented by themselves, or in combination with other operations in either hardware or software, either within the device entirely, or in conjunction with the device and other processer enabled devices in communication with the device, such as a server.

Although a few embodiments have been shown and described, it will be appreciated by those skilled in the art that various changes and modifications can be made to these embodiments without changing or departing from their scope, intent or functionality. The terms and expressions used in the preceding specification have been used herein as terms of description and not of limitation, and there is no intention in the use of such terms and expressions of excluding equivalents of the features shown and described or portions thereof, it being recognized that the disclosure is defined and limited only by the claims that follow.

What is claimed is:

1. A method for building a map for a venue encompassing at least one portable device conveyed by a user using perception sensor data from the portable device, wherein the method is scalable to accommodate any complexity of the venue and wherein the method is configured to be operable for limited resources of the at least one portable device, the method comprising:
a) obtaining motion sensor data from a sensor assembly of the at least one portable device,
b) obtaining perception sensor data from at least one perception sensor for the at least one portable device;
c) generating a navigation solution for the at least one portable device based at least in part on the obtained motion sensor data; and
d) building a 3D geometrical map for the venue using perception sensor data based at least in part on the navigation solution, wherein building the map at least partially compensates for sensor drift, accommodates the limited resources of the at least one portable device and provides scalability despite the complexity of the venue by:
i) building individual 3D maps for zones, wherein the zones are spatially related and each zone is a partition of the venue;
ii) for a subset of zones, wherein each subset comprises a same number of spatially related zones that are contiguous with each other, correcting each subset of the spatially related zones and propagating the correction to each zone in the subset and correcting each 3D map of the zones in each subset;
iii) aggregating corrected subsets and correcting the aggregated corrected subsets by forming a plurality of aggregate transformations followed by correcting each 3D map of the zones in each subset of the aggregate of subsets; and
iv) performing a geodetic correction of the aggregated corrected subsets and geodetically correcting the 3D maps of the zones in each subset in the aggregate of subsets.

2. The method of claim 1, wherein the method provides further scalability despite the complexity of the venue for more complex venues, while still accommodating the limited resources of the at least one portable device and while further improving the compensation for sensor drift, wherein the sensor drifts grow larger for the more complex venue, wherein such furthering of capabilities of the method is provided through the method further comprising identifying a primary structure linking spatially related zones and identifying at least one secondary structure related to the primary structure, wherein each secondary structure links spatially related zones.

3. The method of claim 2, further comprising identifying at least one connector that relates to at least two of the secondary structures related to the primary structure, wherein each connector links spatially related zones.

4. The method of claim 2, wherein the primary structure comprises an aggregate of subsets of spatially related zones, and wherein each secondary structure comprises an aggregate of subsets of spatially related zones.

5. The method of claim 4, wherein each connector comprises an aggregate of subsets of spatially related zones.

6. The method of claim 1, providing at least one additional portable device conveyed by another user, wherein:
a) motion sensor data is obtained from a sensor assembly of the at least one additional portable device;
b) perception sensor data is obtained from at least one perception sensor for the at least one additional portable device;
c) a navigation solution for the at least one additional portable device is generated based at least in part on the obtained motion sensor data; and
d) at least one partial 3D geometrical map for at least a portion of the venue is built using the perception sensor data from the at least one additional portable device obtained from the at least a portion of the venue, based at least in part on the navigation solution generated for the at least one additional portable device and corrected zones, corrected subsets of zones and corrected aggregated subsets of zones.

7. The method of claim 6, wherein the 3D geometrical map for the venue is built based on a partial 3D geometrical map for at least a portion of the venue using perception sensor data obtained by the at least one portable device and corrected zones, corrected subsets of zones and corrected aggregated subsets of zones and on at least a partial 3D geometrical for at least another portion of the venue built using perception sensor data obtained by the at least one additional portable device and different corrected zones, corrected subsets of zones and corrected aggregated subsets of zones 8.

8. The method of claim 7, wherein the 3D geometrical map for the venue is built based at least in part on perception sensor data for each of the portable devices.

9. The method of claim 8, wherein the perception sensor data for each of the portable devices is obtained asynchronously.

10. The method of anyone of claims 1, 2, 3, 6, 7, and 8, wherein the method comprises further improving the 3D geometrical map for the venue using an offline processing resource.

11. The method of claim 10, wherein the offline processing resource is further operative to perform any one or any combination of:
i) correction of zones,
ii) correction of subsets of zones,
iii) correction of aggregated subsets of zones, and
iv) performing geodetic corrections of the aggregated corrected subsets.

12. The method of claim 10, wherein the offline processing resource is further operative in any one or any combination
i) to provide at least one visual marker for at least one component of the 3D geometrical map; and
ii) to enable spatial selection.

13. The method of claim 10, wherein the offline processing resource is further operative to enable deletion of:
i) at least one of the spatially related zones,
ii) at least one subset of the spatially related zones, and
iii) at least one aggregate of subsets of the spatially related zones.

14. The method of claim 13, wherein the offline processing resource is further operative to enable remapping following deletion of at least one of the spatially related zones and to perform at least one reconstruction following remapping to preserve structural integrity.

15. The method of claim 1, wherein the at least one perception sensor is at least one of an optical camera, lidar, a thermal camera, an IR camera, a radar and an ultrasonic sensor.

16. The method of claim 1, wherein the at least one perception sensor is at least one lidar that outputs lidar measurements for the portable device.

17. The method of claim 1, further comprising determining a position for a device within the venue based at least in part on the built map.

18. The method of claim 17, wherein determining the position for the device comprises applying a sequence of corrections derived from the plurality of aggregate transformations for the aggregated corrected subsets.

19. A system for building a map for a venue encompassing at least one portable device conveyed by a user using perception sensor data from the portable device, wherein the system is scalable to accommodate any complexity of the venue and wherein the system is configured to be operable for limited resources of the at least one portable device, the system comprising:
at least one portable device having a sensor assembly configured to output motion sensor data;
at least one perception sensor providing perception sensor data for the at least one portable device; and
at least one processor, coupled to receive the motion sensor data, the perception sensor data, and operative to:
a) obtain motion sensor data from a sensor assembly of the at least one portable device,
b) obtain perception sensor data from at least one perception sensor for the at least one portable device;
c) generate a navigation solution for the at least one portable device based at least in part on the obtained motion sensor data; and
d) build a 3D geometrical map for the venue using perception sensor data based at least in part on the navigation solution, wherein building the map at least partially compensates for sensor drift, accommodates the limited resources of the at least one portable device and provides scalability despite the complexity of the venue by:
i) building individual 3D maps for zones, wherein the zones are spatially related and each zone is a partition of the venue;
ii) for a subset of zones, wherein each subset comprises a same number of spatially related zones that are contiguous with each other, correcting each subset of the spatially related zones and propagating the correction to each zone in the subset and correcting each 3D map of the zones in each subset;
iii) aggregating corrected subsets and correcting the aggregated corrected subsets by forming a plurality of aggregate transformations followed by correcting each 3D map of the zones in each subset of the aggregate of subsets; and
iv) performing a geodetic correction of the aggregated corrected subsets and geodetically correcting the 3D maps of the zones in each subset in the aggregate of subsets.

20. The system of claim 19, wherein the at least one processor is further operative to provide further scalability despite the complexity of the venue for more complex venues, while still accommodating the limited resources of the at least one portable device and while further improving the compensation for sensor drift, wherein the sensor drifts grow larger for the more complex venue, wherein such furthering of capabilities of the system is provided through the at least one processor being further operative to identify a primary structure linking spatially related zones and to identify at least one secondary structure related to the primary structure, wherein each secondary structure links spatially related zones.

21. The system of claim 20, wherein the at least one processor is further operative to identify at least one connector that relates to at least two of the secondary structures related to the primary structure, wherein each connector links spatially related zones.

22. The system of claim 19, wherein the system comprises at least one additional portable device conveyed by another user, wherein:
a) motion sensor data is obtained from a sensor assembly of the at least one additional portable device,
b) perception sensor data is obtained from at least one perception sensor for the at least one additional portable device;
c) a navigation solution is generated for the at least one additional portable device based at least in part on the obtained motion sensor data; and
d) at least one partial 3D geometrical map for at least a portion of the venue is built using the perception sensor data from the at least one additional portable device obtained from the at least a portion of the venue, based at least in part on the navigation solution generated for the at least one additional portable device and corrected zones, corrected subsets of zones and corrected aggregated subsets of zones.

23. The system of claim 22, wherein the 3D geometrical map for the venue is built based on a partial 3D geometrical map for at least a portion of the venue using perception sensor data obtained by the at least one portable device and corrected zones, corrected subsets of zones and corrected aggregated subsets of zones and on at least a partial 3D geometrical for at least another portion of the venue built using perception sensor data obtained by the at least one additional portable device and different corrected zones, corrected subsets of zones and corrected aggregated subsets of zones.

24. The system of claim 19, wherein the system further comprises an offline processing resource and wherein the offline processing resource is operative to improve the 3D geometrical map for the venue.

25. The system of claim 24, wherein the offline processing resource is further operative in any one or any combination of:
i) to perform correction of zones,
ii) to perform correction of subsets of zones,
iii) to perform correction of aggregated subsets of zones,
iv) to perform geodetic corrections of the aggregated corrected subsets;
v) to provide at least one visual marker for at least one component of the 3D geometrical map and
vi) to enable spatial selection;
vii) to enable deletion of at least one of the spatially related zone;
viii) to enable deletion of at least one subset of the spatially related zones;
ix) to enable deletion of at least one aggregate of subsets of the spatially related zones. and
x) to enable remapping following deletion of at least one of the spatially related zones and to perform at least one reconstruction following remapping to preserve structural integrity.

26. The system of claim 19, wherein the at least one perception sensor is at least one of an optical camera, lidar, a thermal camera, an IR camera, a radar and an ultrasonic sensor.

27. The system of claim 19, wherein the at least one processor is further operative to determine a position for a device within the venue based at least in part on the built map.
